(19) United States
(12) Patent Application Publication
(10) Pub. No.: US 2012/0218400 A1
(43) Pub. Date: Aug. 30, 2012

(54) MICROSCOPIC IMAGE PICKUP APPARATUS

(75) Inventors: Tsutomu KURATA, Tokyo-to (JP); Fumio UCHINO, Tokyo-to (JP); Shuji NAKAGAWA, Tokyo-to (JP)

(73) Assignee: OLYMPUS CORPORATION, Tokyo (JP)

(21) Appl. No.: 13/404,394

(22) Filed: Feb. 24, 2012

(30) Foreign Application Priority Data
Feb. 25, 2011 (JP) 2011-040824

(51) Int. Cl. H04N 7/18

(52) U.S. Cl. 348/79; 348/E07.085

(57) ABSTRACT

A microscopic image pickup apparatus for acquiring images of specimens on slide glass samples includes a slide holder pickup section by which the whole image of a slide holder on which a plurality of slide glass samples are arrayed is acquired, a slide glass sample macro-pickup section by which whole images of the slide glass samples are acquired, a slide glass sample micro-pickup section by which micro images of specimen areas of the slide glass samples are acquired under predetermined imaging conditions, and an imaging process control section generating a slide glass sample information management screen. The slide glass sample information management screen is displayed such that the array of display areas for displaying imaging conditions-setting means for setting imaging conditions and for displaying whole images of slide glass samples is paralleled with the array of slide glass samples on a slide holder.

This application claims benefits of Japanese Patent Application No. 2011-40824 filed in Japan on Feb. 25, 2011, the contents of which are incorporated by this reference.

### BACKGROUND OF THE INVENTION

1. Field of the Invention

This invention relates to a microscopic image pickup apparatus which acquires the microscopic images of specimens mounted on slide glasses and particularly to a microscopic image-acquiring apparatus which acquires the microscopic images of specimens mounted on the slide glasses that are arrayed on a slide holder, the slide holder being called “MATPE” and being used for an array, the arrangement, and/or the storage of the slide glass samples.

2. Description of the Related Art

For example, in pathological diagnoses such as cytological diagnosis and histological diagnosis, there is a request that the image of the whole of an observed object should be grasped in order to prevent an observer from overlooking a place to be diagnosed. Also, the computerization of image information has been encouraged even in such pathological diagnoses because of the development of information-processing technologies. Accordingly, there is a request that images acquired in microscopic observation with a video camera or the like should also have as high resolutions as images acquired in conventional microscopic observation with a silver halide film.

In order to achieve these requests, there exists a so-called virtual microscope system in which: an area of an observed object to be imaged is divided into small sections in advance; the image of each of the small divided sections is acquired with high resolution; and the acquired microscopic images of the respective small sections are united so that the image of the whole of the observed object is reconstructed. The use of such a microscope system makes it possible to observe an observed object with a microscope even in an environment in which the observed object does not really exist.

Now, because microscopic images of large numbers of specimens mounted on slide glasses are acquired in hospitals or laboratories, there are necessity to efficiently capture the microscopic images of the vast number of specimens mounted on the slide glasses, necessity to efficiently record and manage sample information, and necessity to efficiently manage specimens mounted on the slide glasses.

Accordingly, in order to efficiently capture the microscopic images of the vast number of specimens mounted on the slide glasses, apparatuses which have been proposed up to now include an apparatus in which: the slide glasses with specimens are automatically carried by a slide loader from a storage unit for the slide glasses to a position at which the microscopic images of the specimens are acquired; and the slide glasses with the specimens are automatically carried by the slide loader to the storage unit after acquiring the microscopic images (refer to Japanese Patent TOKUKAI No. 2003-248176, for example). Also, for example, an exclusive cartridge to the slide glasses as disclosed in Japanese Patent TOKUKAI No. 2007-84111 is used as the storage unit for the slide glasses in such an apparatus (refer to FIG. 1).

Also, in order to simplify the management of specimens mounted on slide glasses up to now, a technology in which: identifiers each of which records information about the medical history of each of patients or the like as specimen information through magnetism or bar code are stuck on the slide glasses respectively; and the identifiers are read through a reader has been known (refer to Japanese Patent TOKUKAI No. HEI 05-215969, for example).

Also, in order to simplify the management of a large amount of specimen information in pathological examinations in hospitals or examination centers, large numbers of slide glasses each of which a specimen is mounted on are held by a multipurpose paper or wooden slide holder which is called “MATPE”, while the slide glasses are being arrayed on the slide holder, and the specimen mounted on the glass slide are managed per slide holder (refer to the website of SHOEI WORK′S CO. LTD, PRODUCT LIST, Class of MATPE, Cardboard MATPE which holds twenty slide glasses, [online] http://www2u.biglobe.ne.jp/˜shoeiss/CIMG1882.JPG and to the website of SHOEI WORK'S CO. LTD, PRODUCT LIST, Class of MATPE, Cardboard MATPE which holds twenty slide glasses,

[online] http://www2u.biglobe.ne.jp/˜shoeiss/CIMG1885.JPG, for example).

As shown in FIG. 2 for example, a multipurpose paper slide holder 1 includes: a cardboard body part 1a which is provided with shallow hold hollows 1an for holding slide glass samples (where n in “1an” denotes a natural number varying from 1 to the maximum number of slide glass samples which can be arrayed on the slide holder 1); and cardboard cover parts 1b which are foldably connected to the body part 1a. When the paper slide holder 1 is kept, the cover parts 1b are folded onto the part of the body part 1a by which the slide glasses are held, so that the cover part 1b play a role as protecting the slide glasses. Also, when the paper slide holder 1 is used, the cover parts 1b are folded toward the respective opposite side to the side on which the slide glasses are held by the body part 1a.

As shown in FIG. 3 for example, a wooden slide holder 1′ includes: a sheet-shaped bottom part 1a′ on which slide glass samples are placed; and a lattice-shaped wooden frame 1b′ which is placed on the sheet-shaped part 1a′ and holds the respective slide glass samples.

Also, in order to improve the efficiency in capturing the microscopic images of large numbers of specimens mounted on slide glass samples more, a MAPTE-holding and -carrying apparatus which places and carries the slide glass samples is proposed for system MATPE the bottoms of the respective sections of which have a special structure making it possible to carry and lift the slide glass samples (refer to Japanese Patent TOKUKAI No. 2007-147399, for example).

Now, hospitals and so on manage large numbers of slide glass samples by the multipurpose slide holder, as described above.

### SUMMARY OF THE INVENTION

A microscopic image pickup apparatus according to the present invention, which is used for acquiring the images of specimens on slide glass samples, is characterized in that the microscopic image pickup apparatus includes: a slide holder pickup section by which the whole image of a slide holder on which a plurality of slide glass samples are arrayed is acquired; a slide glass sample macro-pickup section by which the whole images of the slide glass samples are acquired; a slide glass sample micro-pickup section by which micro images of specimen areas of the slide glass samples are acquired under predetermined imaging conditions; and an imaging process control section generating a slide glass sample information management screen for managing slide glass sample information, the slide glass sample information management screen being displayed in such a way that the array of display areas for displaying imaging conditions-setting means for setting the imaging conditions and for displaying the whole images of slide glass samples is paralleled with the array of slide glass samples on a slide holder.

Also, in a microscopic image pickup apparatus according to the present invention, it is preferred that the imaging process control section generates a slide glass sample information management screen which is displayed in such a way that micro images of specimen areas of the slide glass samples acquired by the slide glass sample micro-pickup section are made to correspond to the whole images of the slide glass samples acquired by the slide glass sample macro-pickup section respectively.

Also, a microscopic image pickup apparatus according to the present invention, which is used for acquiring the images of specimens on slide glass samples, is characterized in that: the microscopic image pickup apparatus includes a slide holder pickup section by which the whole image of a slide holder on which a slide glass sample is arrayed is acquired, a slide glass sample macro-pickup section by which the whole image of a slide glass sample is acquired, a slide glass sample micro-pickup section by which a micro image of a specimen area of the slide glass sample are acquired under predetermined imaging conditions, and an imaging process control section which controls imaging processes for the images of a slide holder and a slide glass sample; the imaging process control section includes a screen display control section and an pickup control section; the screen display control section generates a slide glass sample information management screen including display areas each of which displays the information of a slide glass sample and the array of which is paralleled with the array of a slide glass sample on a slide holder, a slide holder whole image-displaying screen displaying the whole image of a slide holder, a micro image-displaying screen including a setting area for setting a desired part of a specimen area of a slide glass sample the micro image of which should be displayed and a display area for enlarging and displaying the micro image of the part of the specimen area set through the setting area, and a command screen for commanding the microscopic image pickup apparatus to perform a predetermined imaging process and to display a predetermined screen; and, when the microscopic image pickup apparatus is commanded to perform a imaging process on the command screen, the pickup control section triggers the slide holder pickup section so that the whole image of a slide holder is acquired, the pickup control section triggers the slide glass sample macro-pickup section so that the whole image of a slide glass sample is acquired, and then the pickup control section next triggers the slide glass sample micro-pickup section so that a micro image of a specimen area of the slide glass sample is acquired.

The present invention is capable of offering a microscopic image pickup apparatus in which: imaging conditions for each of slide glass samples can be set while a situation where the slide glass samples are arrayed on a slide holder is being checked, by the versatile slide holder; and information management for observations of the acquired images of the individual slide glass samples or the like can be performed efficiently.

These features and advantages of the present invention will become apparent from the following detailed description of the preferred embodiments carried out in conjunction with the accompanying drawings.

### BRIEF DESCRIPTION OF THE DRAWINGS

FIG. 1 is an explanatory view showing one example of cartridges exclusive to a microscopic image pickup apparatus with a conventional slide roller.

FIG. 2 is an explanatory view showing a paper slide holder which is popularly used.

FIG. 3 is an explanatory view showing a wooden slide holder which is popularly used.

FIG. 4 is a block diagram conceptually showing the constitution of the whole of a microscopic image pickup apparatus according to one embodiment of the present invention.

FIG. 5 is a perspective view showing transportation in the microscopic image pickup apparatus of the present embodiment and the specific external constitution of the microscopic image pickup apparatus.

FIGS. 6A, 6B, and 6C are a side view, a front view, and a plane view which show a main part of the apparatus shown in FIG. 5, respectively.

FIGS. 7A, 7B, and 7C are a plane view, a side view, and a front view which show the top end part of an articulated arm which is provided for a slide holder-transporting unit of the microscopic image pickup apparatus of the present embodiment, respectively.

FIG. 8 is a perspective view showing one example of constitutions for a paper slide holder-holding part which is provided for the slide holder-transporting unit of the microscopic image pickup apparatus of the present embodiment.

FIG. 9 is an explanatory view partially showing a state of the paper slide holder-holding part shown in FIG. 8 holding or not holding a paper slide holder, FIG. 9A is a view showing a state in which the paper slide holder-holding part releases its hold of a paper slide holder, and FIG. 9B is a view showing a state in which the paper slide holder-holding part holds the paper slide holder.

FIG. 10 is an explanatory view partially showing a situation where the slider holder-transporting unit transports the paper slide holder in the microscopic image pickup apparatus of the present embodiment.

FIG. 11 is an explanatory view showing one example of constitutions for a wooden slide holder-holding part which is provided for the slide holder-transporting unit of the microscopic image pickup apparatus of the present embodiment, FIG. 11A is a perspective view in which the wooden slide holder-holding part is viewed from below, and FIG. 11B is a perspective view in which the wooden slide holder is viewed from above.

FIG. 12 is an explanatory view partially showing a situation where the slider holder-transporting unit transports the wooden slide holder in the microscopic image pickup apparatus of the present embodiment.

FIG. 13 is a perspective view showing one example of constitutions for a slide glass sample-holding part which is provided for a slide glass sample-transporting device for macro image acquisition in the microscopic image pickup apparatus of the present embodiment.

FIG. 14 is an explanatory view showing a state in which the slide glass sample-holding part shown in FIG. 13 is fitted to the top end part of an articulated arm.

FIG. 15 is an explanatory view showing a situation where: a slide glass sample is held by the slide glass sample-holding part shown in FIG. 13 and is transported, the slide glass sample-holding part being fitted to the top end part of the articulated arm provided for the slide glass sample-transporting device for macro image acquisition in the microscopic image pickup apparatus of the present embodiment.

FIG. 16 is an explanatory view showing the structures of a slide glass sample information management screen and a command screen which are provided for a screen display control section of the microscopic image pickup apparatus of the present embodiment.

FIG. 17 is an explanatory view showing the structure of a slide holder whole image-displaying screen which is provided for the screen display control section of the microscopic image pickup apparatus of the present embodiment.

FIG. 18 is an explanatory view showing the structure of an imaging condition-setting screen which is provided for the screen display control section of the microscopic image pickup apparatus of the present embodiment.

FIG. 19 is an explanatory view showing the structure of a micro image-displaying screen which is provided for the screen display control section of the microscopic image pickup apparatus of the present embodiment.

FIG. 20 is an explanatory view showing the structure of a progress state-displaying screen which is provided for the screen display control section of the microscopic image pickup apparatus of the present embodiment.

FIG. 21 is a flow chart showing a procedure for acquiring the image of a slide glass sample using the microscopic image pickup apparatus of the present embodiment.

FIG. 22 is a block diagram schematically showing the relation between the positions of members which participate in transportation of a slide holder and a slide glass sample in the microscopic image pickup apparatus of the present embodiment.

FIG. 23 is an explanatory view showing one example of situations where the image of the whole of a slide glass sample acquired by the slide glass sample macro-pickup section and the identification information of the slide glass sample detected by a slide glass sample identification information-detecting device are displayed in the slide glass sample information management screen in the microscopic image pickup apparatus of the present embodiment.

FIG. 24 is an explanatory view showing one example of situations where the image of the whole of the slide glass sample is displayed in the slide glass sample information management screen after acquiring the image of a micro image of a specimen area of the slide glass sample by the slide glass sample micro-pickup section in the microscopic image pickup apparatus of the present embodiment.

FIG. 25 is a flow chart showing a procedure for acquiring the image of a slide glass sample using a variation of the microscopic image pickup apparatus of the present embodiment.

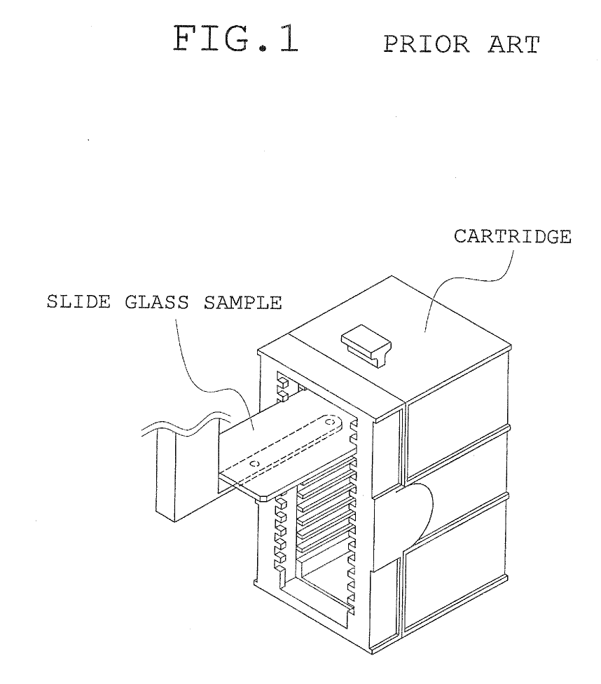

### DETAILED DESCRIPTION OF THE PREFERRED EMBODIMENTS

Prior to a description of the present embodiment for microscopic image pickup apparatuses according to the present invention, operation and its effects in microscopic image pickup apparatuses according to the present invention will be explained.

As in the present invention, a microscopic image pickup apparatus is formed in such a way that: the microscopic image pickup apparatus includes a slide holder pickup section by which the whole image of a slide holder on which a plurality of slide glass samples are arrayed is acquired, a slide glass sample macro-pickup section by which the whole image of the slide glass samples is acquired, a slide glass sample micro-pickup section by which micro images of specimen areas of the slide glass samples are acquired under predetermined imaging conditions, and an imaging process control section generating a slide glass sample information management screen for managing slide glass sample information, the slide glass sample information management screen being displayed in such a way that the array of display areas for displaying imaging conditions-setting means for setting the imaging conditions and for displaying the whole images of slide glass samples are paralleled with the array of slide glass samples on a slide holder; and the image of the whole of the slide holder, the image of the whole of a slide glass sample, and the image of a micro part of a specimen area on the slide glass sample can be acquired and the acquired image of the whole of the slide holder and the acquired image of the whole of or the micro part of the specimen area of the glass sample can be displayed. As a result, the present invention makes it possible to set imaging conditions for slide glass samples individually and verify information of the acquired images of each of the slide glass samples individually on a screen by the slide holder which is managed in a hospital while a state of the slide glass samples arrayed on the slide holder is being checked, so that it is possible not only to prevent the acquisition of the image of the wrong slide glass sample due to the misidentification of the slide glass sample but also to effectively manage information of the slide glass samples.

### Schematic Constitution of the Whole of Apparatus

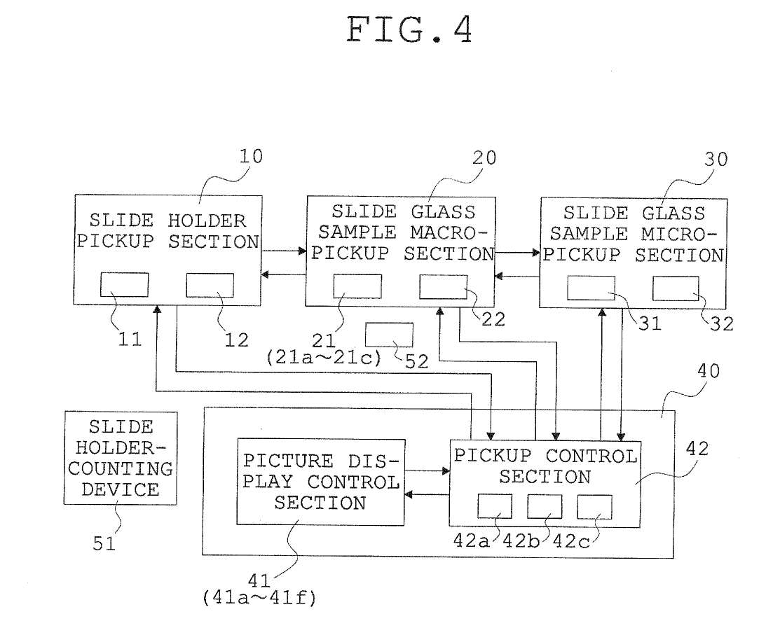

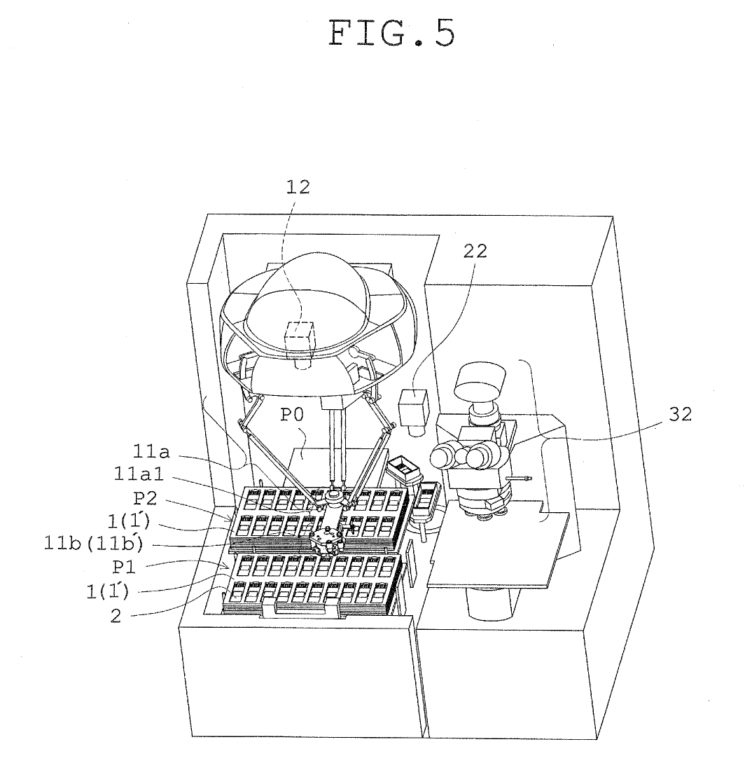

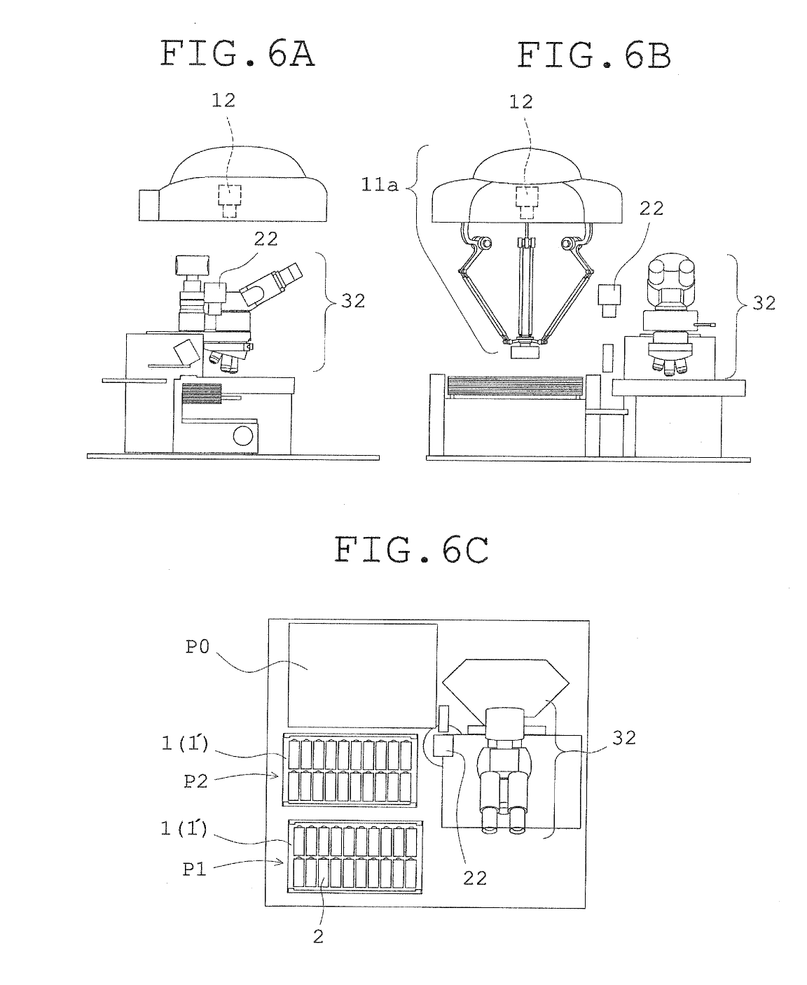

FIG. 4 is a block diagram conceptually showing the constitution of the whole of a microscopic image pickup apparatus according to one embodiment of the present invention. FIG. 5 is a perspective view showing transportation in the microscopic image pickup apparatus of the present embodiment and the specific external constitution of the microscopic image pickup apparatus. FIG. 6 is an explanatory view showing a main part of the apparatus shown in FIG. 5 when the apparatus is viewed from three directions, FIG. 6A is a side view of the main part of the apparatus, FIG. 6B is a front view of the main part of the apparatus, and FIG. 6C is a plane view of the main part of the apparatus. Besides, the numeral reference 1 (1′) denotes the slide holder and the numeral reference 2 denotes the slide glass samples in FIGS. 5 and 6.

The microscopic image pickup apparatus of the present embodiment includes a slide holder pickup section 10, a slide glass sample macro-pickup section 20, a slide glass sample micro-pickup section 30, and an imaging process control section 40, as shown in FIG. 4. Besides, an image-acquiring means like a CCD which the slide glass sample macro-pickup section 20 includes may be different from that which the slide glass sample micro-pickup section 30 includes, as in the present embodiment. However, microscopic image pickup apparatuses according to the present invention may be formed in such a way that: the image-acquiring means provided for the slide glass sample micro-pickup section 30 is used also for the slide glass sample macro-pickup section 20; and the magnification of an objective lens provided for an image-acquiring system is changed.

### Schematic Constitution of Slide Holder Pickup Section

The slide holder pickup section 10 is composed of a slide holder-transporting unit 11 and a slide holder pickup section 12.

The slide holder pickup section 12 is formed in such a way that the image of the whole of a slide holder 1 on which slide glass samples 2 are arrayed can be acquired by the slide holder pickup section 12.

The slide holder-transporting unit 11 is formed in such a way that the slide holder-transporting unit 11 can perform: the first transportation operation in which the slide holder-transporting unit 11 transports a slide holder 1 configured at its predetermined standby position P1 to an image acquisition position P2 in which the whole images of slide holders 1 are acquired by the slide holder pickup section 12; and the sixth transportation operation in which the slide holder-transporting unit 11 returns to the predetermined standby position P1 the slide holder 1 located in the image acquisition position P2 of the slide holder pickup section 12.

For more detailed explanation of the slide holder-transporting unit 11, the slide holder-transporting unit 11 is formed in such a way that the slide holder-transporting unit 11 includes an articulated arm 11a capable of moving in the three-dimensional directions and a slide holder-holding part 11b, for example, as shown in FIG. 5.

The articulated arm 11a includes an arm for publically-known articulated robots such as parallel link robots, for example. The articulated arm 11a is arranged in such a way that the articulated arm 11a runs downward from above. Also, the top end part 11a1 of the articulated arm 11a is formed in such a way that the slide holder-holding part 11b is removably fitted to the top end part 11a1 of the articulated arm 11a.

The slide holder-holding part 11b is formed in such a way that the slide holder-holding part 11b can hold the slide holder 1 from above and can release its hold of the slide holder 1. Also, different types of slide holder-holding part 11b are used in accordance with different types of slide holder 1 (such as paper slide holders and wooden slide holders) which are commonly used.

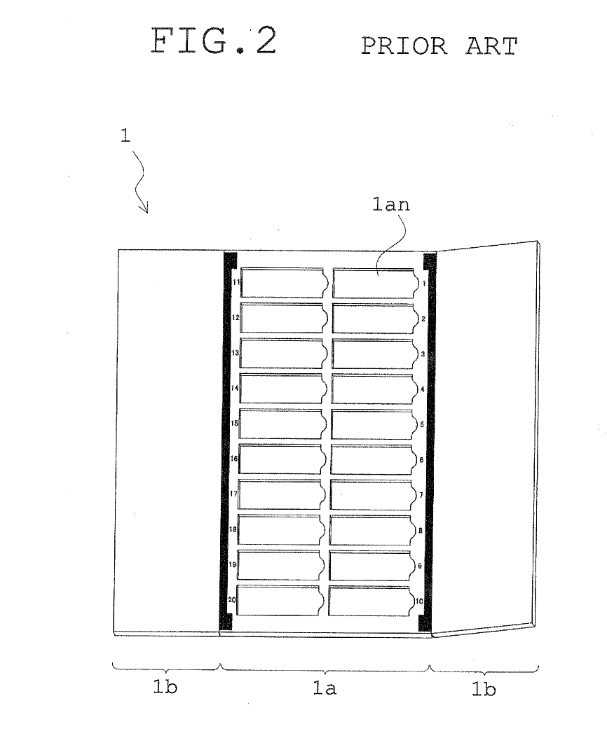

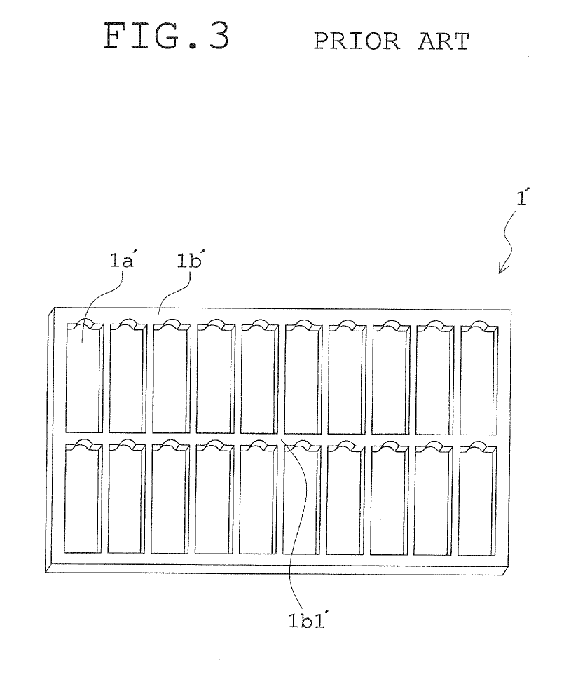

Besides, for the sake of convenience in an explanation for the present embodiment, the below explanation presupposes that: paper and wooden slide holders used in the present invention can hold twenty slide glass samples respectively as shown in FIGS. 2 and 3; and slide holder-holding parts 11b which are designed in accordance with these slide holders are provided for the slide holder-transporting unit 11.

### Constitution Example of Top End Part of Articulated Arm

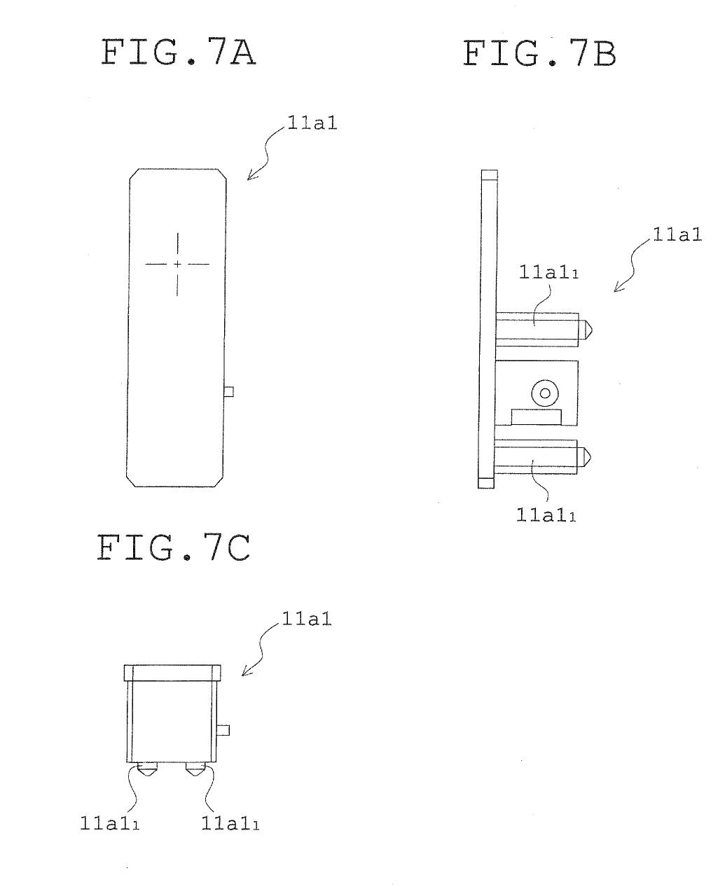

FIG. 7 is an explanatory view showing the constitution of the top end part of an articulated arm which is provided for a slide holder-transporting unit of the microscopic image pickup apparatus of the present embodiment, FIG. 7A is a plane view of the top end part of the arm, FIG. 7B is a side view of the top end part of the arm, and FIG. 7C is a front view of the top end part of the arm.

The top end part 11a1 of the articulated arm 11a includes an adhesion part 11a1₁, as shown in FIG. 7. The adhesion part 11a1₁ is formed in such a way that the adhesion part 11a1₁ can adhere to the slide holder-holding part 11b through magnetism or air and can release the adhesion of the adhesion part 11a1₁ to the slide holder-holding part 11b.

### Constitution of Paper Slide Holder-Holding Part

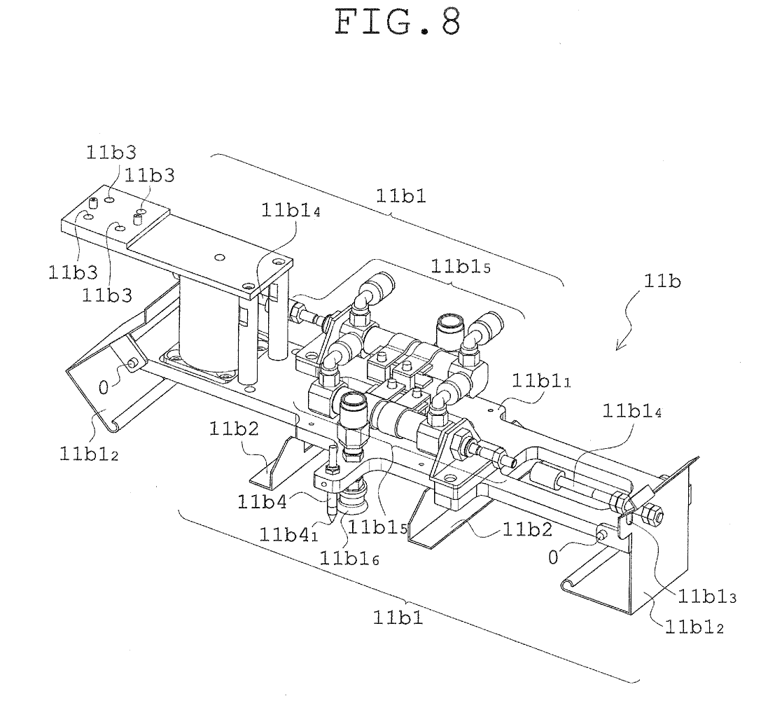

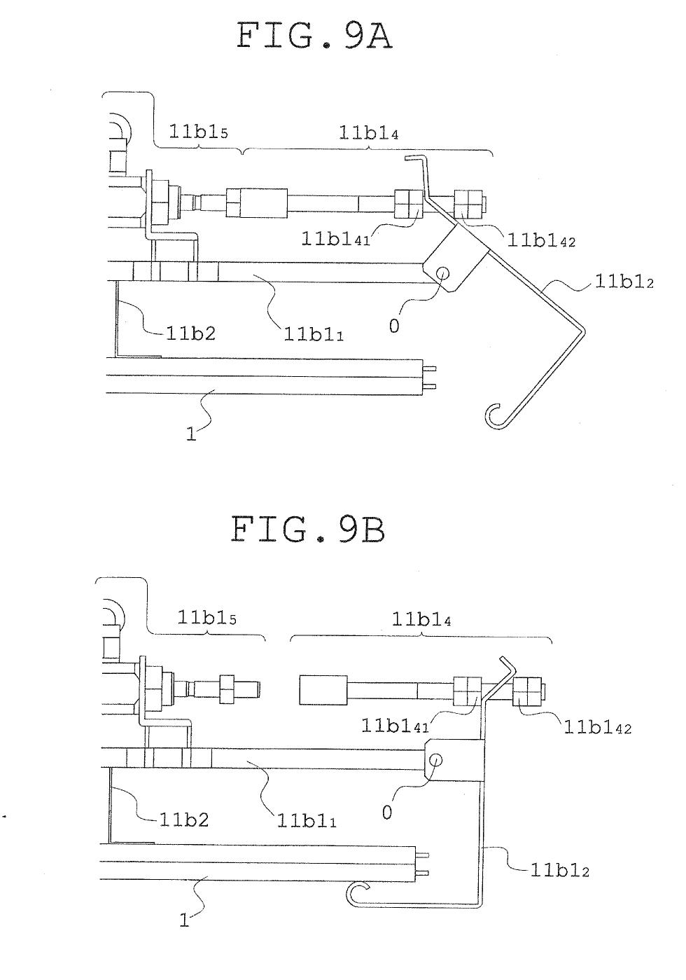

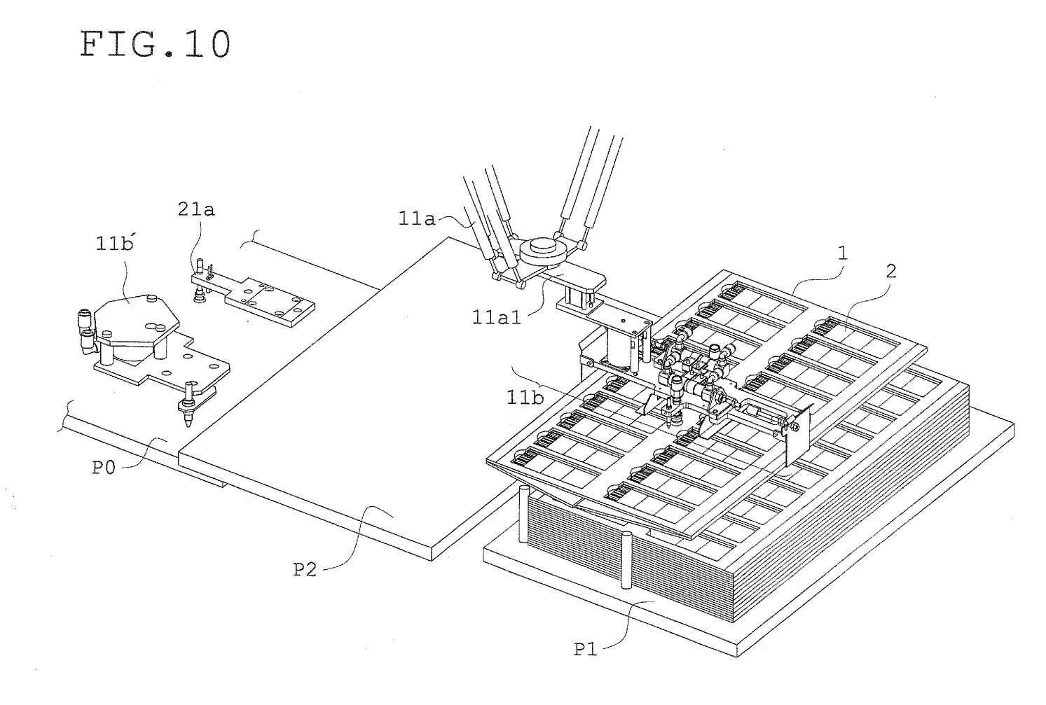

FIG. 8 is a perspective view showing one example of constitutions for a paper slide holder-holding unit which is provided for the slide holder-transporting unit of the microscopic image pickup apparatus of the present embodiment. FIG. 9 is an explanatory view partially showing a state of the paper slide holder-holding unit shown in FIG. 8 holding or not holding a paper slide holder, FIG. 9A is a view showing a state in which the paper slider holder-holding unit releases its hold of a paper slide holder, and FIG. 9B is a view showing a state in which the paper slider holder-holding unit holds the paper slide holder. FIG. 10 is an explanatory view partially showing a situation where the slider holder-transporting unit transports a paper slide holder in the microscopic image pickup apparatus of the present embodiment.

The paper slide holder-holding part 11b which is shown in FIG. 8 includes: a paper slide holder-holding mechanism 11b1 capable of pinching a paper slide holder 1 shown in FIG. 10 through the both lateral sides of the paper slide holder 1 which run in the longitudinal direction of the paper slide holder 1 and capable of releasing its pinch of the paper slide holder 1; a contact part 11b2; and a first groove 11b3 to be adhered, for example.

The paper slide holder-holding mechanism 11b1 is formed in such a way that the paper slide holder-holding mechanism 11b1 includes an elongate plate-shaped part 11b1₁, a pair of hook-shaped parts 11b1₂, a pair of penetration holes 11b1₃ (one of which is only shown in FIG. 8), a pair of rod-shaped parts 11b1₄, and a pair of air-injection and exhaust parts 11b1₅.

The hook-shaped parts 11b1₂ are fitted to shafts O which are provided on the both edges of the plate-shaped parts 11b1₁ and which run in the lateral direction of the plate-shaped part 11b1₁, respectively, in such a way that the hook-shaped parts 11b1₂ can rotate on the shafts O respectively.

The penetration holes 11b1₃ are provided on one ends of the hook-shaped parts 11b1₂ respectively.

The rod-shaped parts 11b1₄ are provided on the plate-shaped parts 11b1₁ respectively in such a way that the rod-shaped parts 11b1₄ run in the longitudinal direction of the plate-shaped part 11b1₁. Also, the rod-shaped parts 11b1₄ penetrate through the penetration holes 11b1₃ provided for the hook-shaped parts 11b1₂ respectively while the rod-shaped parts 11b1₄ are being freely fitted into the penetration holes 11b1₃ respectively. In addition, each of the rod-shaped parts 11b1₄ includes: an inner surface-pushing part 11b1₄₁ which can push the inner surface around the penetration hole 11b1₃ in a hook-shaped part 11b1₂; and an outer surface-pushing part 11b1₄₂ which can push the outer surface around the penetration hole 11b1₃ in the hook-shaped part 11b1₂.

The air-injection and exhaust parts 11b1₅ are formed in such a way that the rod-shaped parts 11b1₄ can be biased by the air-injection and exhaust parts 11b1₅ through air pressure in a direction in which the rod-shaped parts 11b1₄ approach the air-injection and exhaust parts 11b1₅ respectively and in a direction in which the rod-shaped parts 11b1₄ separate from the air-injection and exhaust parts 11b1₅ respectively.

Besides, the paper slide holder-holding mechanism 11b1 shown in FIG. 8 may be provided not only with the air-injection and exhaust parts 11b1₅ but also with a spring (not shown in the drawings) by which the rod-shaped parts 11b1₄ are biased in a direction in which the rod-shaped parts 11b1₄ approach the air-injection and exhaust parts 11b1₅ respectively.

Also, the paper slide holder-holding mechanism 11b1 which is shown in FIG. 8 further includes a paper slide holder adhesion part 11b1₆ which adheres to the paper slide holder.

The paper slide holder adhesion part 11b1₆ is formed in such a way that: the paper slide holder adhesion part 11b1₆ can adhere to an area in the middle of the upper-side face of the paper slide holder 1, slide glass samples being not placed on the area in the middle of the upper side face of the paper slide holder 1; and the paper slide holder adhesion part 11b1₆ can release the adhesion of the paper slide holder adhesion part 11b1₆ to the paper slide holder 1.

The contact part 11b2 is formed in such a way that the contact part 11b2 can come into contact with an area in the middle of the upper-side face of a paper slide holder 1 pinched by the paper slide holder-holding mechanism 11b1, slide glass samples being not placed on the area in the middle of the upper side face of the slide holder 1.

While the top end of the adhesion part 11a1₁ of the articulated arm 11a is being fitted to the first groove 11b3, the adhesion part 11a1₁ adheres to the paper slide holder-holding part 11b or releases the adhesion of the adhesion part 11a1₁ to the paper slide holder-holding part 11b.

### Operation of Paper Slide Holder-Holding Part

The paper slide holder-holding part 11b shown in FIG. 8 holds a paper slide holder 1 and releases its hold of the paper slide holder 1 in the following manners.

In the case where the paper slide holder-holding part 11b holds the paper slide holder 1, the paper slide holder adhesion part 11b1₆ first adheres to a paper slide holder 1 when the slide holder-holding part 11b is located at a position in which the paper slide holder-holding mechanism 11b1 can pinch the paper slide holder 1 through the both long sides of the paper slide holder 1. As a result, the main body 1a of the paper slide holder 1, together with a cover part 1b which is folded in the longitudinal direction of the paper slide holder 1 and on the back side of the paper slide holder 1, floats in the air. Next, air is injected into the air-injection and exhaust parts 11b1₅, so that the rod-shaped parts 11b1₄ are pushed and move in directions in which the rod-shaped parts 11b1₄ separate from each other, respectively and the inner surface-pushing parts 11b1₄₁ of the rod-shaped parts 11b1₄ push the inner surfaces of the hook-shaped parts 11b1₂, respectively. As a result, the hook-shaped parts 11b1₂ rotate on the shafts O in directions in which the hook-shaped parts 11b1₂ approach each other, respectively, so that the paper slide holder-holding mechanism 11b1 pinches the paper slide holder 1. Also, at this point, the contact part 11b2 comes into contact with the area in the middle of the upper face of the paper slide holder 1 pinched by the paper slide holder-holding mechanism 11b1, slide glass samples being not placed on the area in the middle of the upper face of the paper slide holder 1. As a result, the process of holding the paper slide holder 1 by the paper slide holder-holding part 11b is complete.

In the case where the paper slide holder-holding part 11b releases its hold of the paper slide holder 1, air is first released through the air-injection and exhaust parts 11b1₅ when the slide holder-holding part 11b is located in a position in which the paper slide holder-holding mechanism 11b1 can release the paper slide holder 1 pinched by the paper slide holder-holding mechanism 11b1. As a result, the rod-shaped parts 11b1₄ are biased and move in directions in which the rod-shaped parts 11b1₄ approach each other, respectively and the outer surface-pushing parts 11b1₄₂ of the rod-shaped parts 11b1₄ push the outer surfaces of the hook-shaped parts 11b1₂, respectively. As a result, the hook-shaped parts 11b1₂ rotate on the shafts O in directions in which the hook-shaped parts 11b1₂ separate from each other, respectively, so that the paper slide holder-holding mechanism 11b1 release the paper slide holder 1 pinched by the paper slide holder-holding mechanism 11b1. Next, the paper slide holder adhesion part 11b1₆ releases its adhesion to the paper slide holder 1. As a result, the main body 1a of the paper slide holder 1, together with a cover part 1b which is folded in the longitudinal direction of the paper slide holder 1 and on the back side of the paper slide holder 1, goes downward. As a result, the process of releasing the paper slide holder 1 held by the paper slide holder-holding part 11b is complete.

In addition, the paper slide holder-holding part 11b shown in FIG. 8 includes a hold state-detecting sensor 11b4.

The hold state-detecting sensor 11b4 is provided for the paper slide holder-holding part 11b in such a way that the top end 11b4₁ of the hold state-detecting sensor 11b4 comes into contact with the paper slide holder 1 when the paper slide holder-holding mechanism 11b1 holds the paper slide holder 1. And, the hold state-detecting sensor 11b4 is formed in such a way that: the hold state-detecting sensor 11b4 can detect whether the paper slide holder-holding part 11b1 holds a paper slide holder 1 or not; and the holder state-detecting sensor 11b4 can detect a state of the paper slide holder-holding part 11b holding a paper slide holder 1, by measuring pressure to the top end 11b4₁ or the like.

### Constitution of Wooden Slide Holder-Holding Part

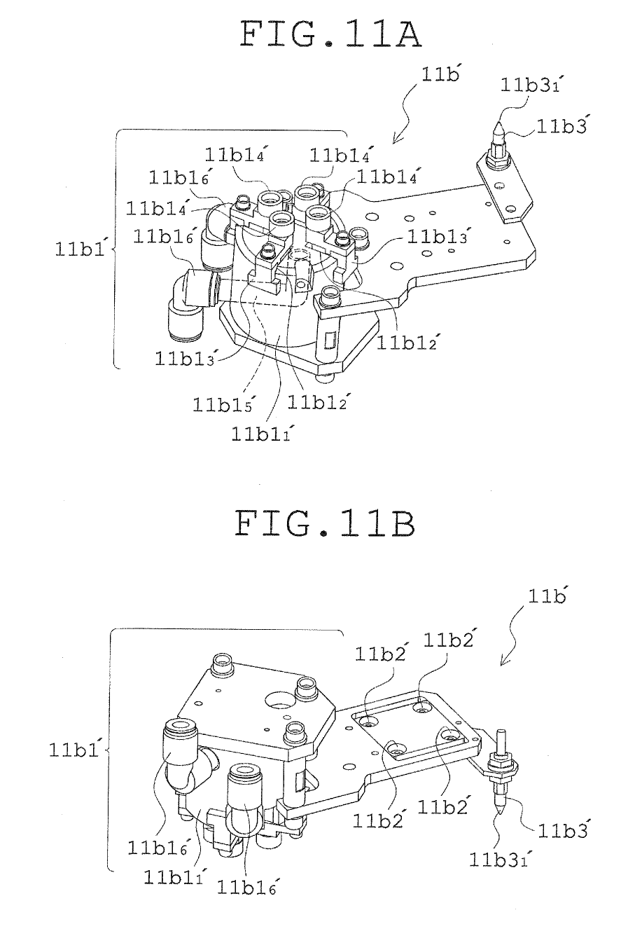

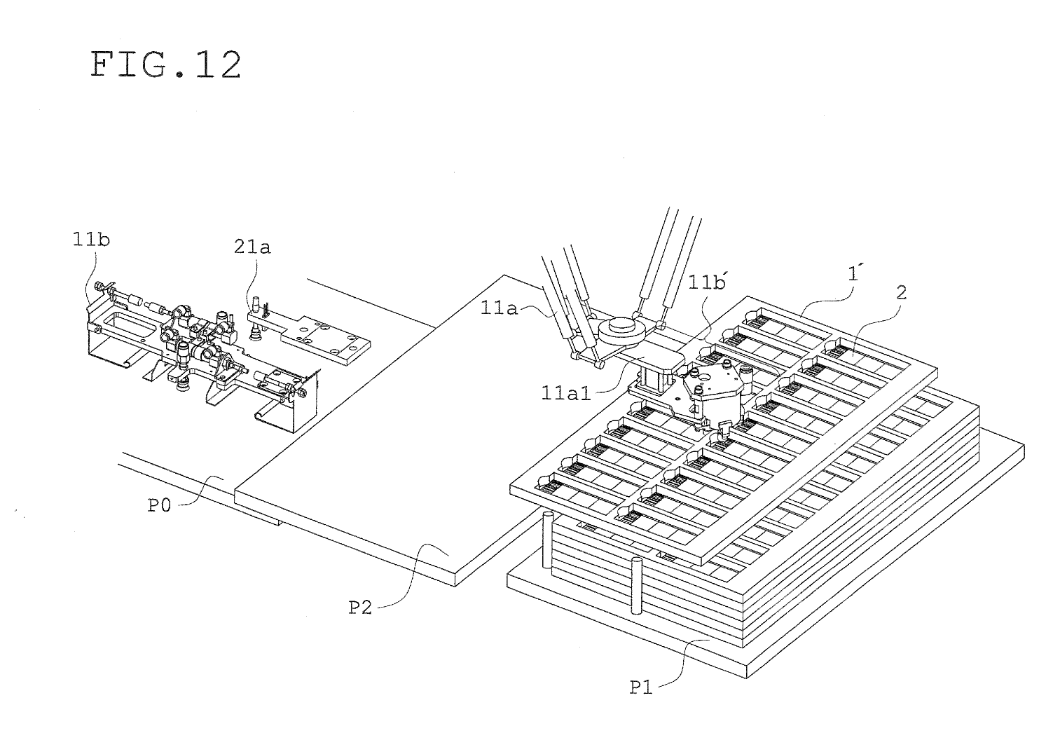

FIG. 11 is an explanatory view showing one example of constitutions for a wooden slide holder-holding unit which is provided for the slide holder-transporting unit of the microscopic image pickup apparatus of the present embodiment, FIG. 11A is a perspective view in which the wooden slide holder-holding unit is viewed from below, and FIG. 11B is a perspective view in which the wooden slide holder is viewed from above. FIG. 12 is an explanatory view partially showing a situation where the slider holder-transporting unit transports a wooden slide holder in the microscopic image pickup apparatus of the present embodiment. Besides, the numerical reference 1′ in FIG. 12 denotes a wooden slide holder.

The wooden slide holder-holding part 11b′ which is shown in FIG. 11 includes a wooden slide holder-holding mechanism 11b1′ and a second groove 11b2′ to be adhered.

The wooden slide holder-holding mechanism 11b1′ is formed in such a way that the wooden slide holder-holding mechanism 11b1′ includes a cylindrical member 11b1₁′, a groove 11b1₂′ the cross section of which is shaped like the letter, “T”, a fitting part 11b1₃′ the cross section of which is shaped like the letter, “T”, a wood frame connection part 11b1₄′, a passage 11b1₅′, and an air-injection and exhaust part 11b1₆′.

The four grooves 11b1₂′ the cross section of each of which is shaped like the letter, “T” are formed on the upper end part of the cylindrical member 11b1₁′ in such a way that the four grooves 11b1₂′ are symmetrically formed along the radial directions of the circle of cylindrical member 11b1₁′.

The fitting parts 11b1₃′ the cross section of each of which is shaped like the letter, “T” are fitted to the grooves 11b1₂′ the cross section of each of which is shaped like the letter, “T”, respectively, in such a way that the fitting parts 11b1₃′ can move on the insides of the grooves 11b1₂′ by a predetermined distance respectively.

The wood frame contact parts 11b1₄′ are made of an elastic material like rubber for example and are provided on one ends of the fitting parts 11b1₃′ the cross section of each of which is shaped like the letter, “T”, respectively, the one ends of the fitting parts 11b1₃′ being located nearest to the center of the circle of the cylindrical part 11b1₁′.

The passage 11b1₅′ is formed inside the cylindrical part 11b1₁′ and connects the center of the circle of the cylindrical part 11b1₁′ to the grooves 11b1₂′ the cross section of each of which is shaped like the letter, “T”.

The air-injection and exhaust part 11b1₆′ is formed in such a way that: air can be injected into and released from the passage 11b1₅′ through the air-injection and exhaust part 11b1₆′; and the rod-shaped parts 11b1₄ can be biased by the air-injection and exhaust parts 11b1₆′ through air pressure in directions in which the fitting parts 11b1₃′ separate from each other and in directions in which the fitting parts 11b1₃′ approach each other.

In addition, the wooden slide holder-holding mechanism 11b1′ may be provided not only with the air-injection and exhaust part 11b1₆′ but also with a spring (not shown in the drawings) by which the fitting parts 11b1₃′ are biased in directions in which the fitting parts 11b1₃′ approach each other.

While the top end of the adhesion part 11a1₁ of the articulated arm 11a is being fitted to the second adhesion groove 11b2′, the adhesion part 11a1₁ adheres to the wooden slide holder-holding part 11b′ or releases the adhesion of the adhesion part 11a1₁ to the wooden slide holder-holding part 11b′.

### Operation of Wooden Slide Holder-Holding Part

The wooden slide holder-holding part 11b′ shown in FIG. 11 holds a wooden slide holder 1′ and releases its hold of a wooden slide holder 1′ in the following manners.

In the case where the wooden slide holder-holding part 11b′ holds a wooden slide holder 1′, air is first released from the passage 11b1₅′ through the air-injection and exhaust part 11b1₆′ when the wooden slide holder-holding part 11b′ is located in a position in which the wooden slide holder-holding mechanism 11b1′ can pinch from four directions a cross-shaped rib part 1b1′ in the middle of the paper slide holder 1′ (or, a cross-shaped part which is located in the middle of a lattice-shaped wood frame part 1b′ shown in FIG. 3), so that the fitting parts 11b1₃′ the cross section of each of which is shaped like the letter, “T” are biased in directions in which the fitting parts 11b1₃′ approach each other, respectively and the cross sections of the fitting parts 11b1₃′ move on the inside of the grooves 11b1₂′ shaped like the letter, “T”, respectively. As a result, the wood frame contact parts 11b1₄′ pinch from four directions the cross-shaped rib part 1b1′ located in the middle of the wooden slide holder 1′, so that the process of holding the wooden slide holder 1′ by the wooden slide holder-holding part 11b′ is complete.

In the case where the wooden slide holder-holding part 11b′ releases its hold of a wooden slide holder 1′, air is first injected into the passage 11b1₅′ through the air-injection and exhaust parts 11b1₆′ when the wooden slide holder-holding part 11b′ is located in a position in which the wooden slide holder-holding mechanism 11b1′ can release the cross-shaped rib part 1b1′ pinched by the wooden slide holder-holding mechanism 11b1′ from four directions, the cross-shaped rib part 1b1′ being located in the middle of the wooden slide holder 1′. As a result, the fitting parts 11b1₃′ the cross section of each of which is shaped like the letter, “T” are biased in directions in which the fitting parts 11b1₃′ separate from each other, respectively and the cross sections of the fitting parts 11b1₃′ move in the grooves 11b1₂′ shaped like the letter, “T”, respectively, and the wood frame contact parts 11b1₄′ release the cross-shaped rib part 1b1′ pinched from four directions by the wood frame contact parts 11b1₄′, the cross-shaped rib part 1b1′ being located in the middle of the wooden slide holder 1′. As a result, the process of releasing the wooden slide holder 1′ held by the wooden slide holder-holding part 11b′ is complete.

In addition, the wooden slide holder-holding part 11b′ shown in FIG. 11 includes a hold state-detecting sensor 11b3′.

The hold state-detecting sensor 11b3′ is provided for the wooden slide holder-holding part 11b′ in such a way that the top end 11b3₁′ of the hold state-detecting sensor 11b3′ comes into contact with a wooden slide holder 1′ when the wooden slide holder-holding mechanism 11b1′ holds the wooden slide holder 1′. And, the hold state-detecting sensor 11b3′ is formed in such a way that: the hold state-detecting sensor 11b3′ can detect whether the wooden slide holder-holding part 11b1′ holds the wooden slide holder 1′ or not; and the holder state-detecting sensor 11b3′ can detect a state of the wooden slide holder-holding part 11b′ holding the wooden slide holder 1′, by measuring pressure to the top end 11b3₁′ or the like.

### Schematic Constitution of Slide Glass Sample Macro-Pickup Section

The slide glass sample macro-pickup section 20 is composed of a slide glass sample-transporting device 21 for macro image acquisition and a slide glass sample macro-pickup device 22.

The slide glass sample macro-pickup device 22 is formed in such a way that the image of the whole of a slide glass sample can be acquired by the slide glass sample macro-pickup device 22.

The slide glass sample-transporting device 21 for macro image acquisition is formed in such a way that: the slide glass sample-transporting device 21 can take a predetermined slide glass sample from a slide holder which is located in the position in which the images of slide holders are acquired by the slide holder pickup device 12; the slide glass sample-transporting device 21 can perform a second transportation operation in which the slide glass sample-transporting device 21 transports the taken slide glass sample to the position in which the images of slide glass samples are acquired by the slide glass sample macro-pickup device 22; and the slide glass sample-transporting device 21 can perform a fifth transportation operation in which the slide glass sample-transporting device 21 transports the slide glass sample located in the position in which the images of slide glass samples are acquired by the slide glass sample macro-pickup device 22 so that the slide glass sample returns to the original position of the slide glass sample on the slide holder located in the position in which the images of slide holders are acquired by the slide holder pickup device 12.

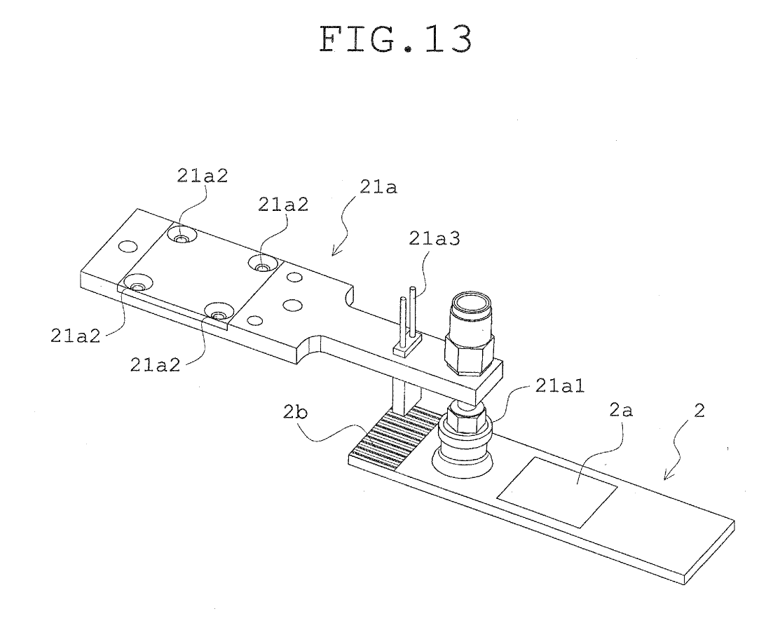

For a more detailed explanation of the slide glass sample-transporting device 21, the slide glass sample-transporting device 21 for macro image acquisition is formed in such a way that the slide glass sample-transporting device 21 at least includes: the articulated arm 11a shown in FIG. 5; and a slide glass sample-holding part 21a which is shown in FIG. 13 and described below. Besides, as described above, the slide glass sample macro-pickup section 20 may be provided with an image-acquiring means like a CCD which is different from that provided for the slide glass sample micro-pickup section 30, as in the present embodiment. However, microscopic image pickup apparatus according to the present invention may be formed in such a way that: the image-acquiring means provided for the slide glass sample micro-pickup section 30 is used also for the slide glass sample macro-pickup section 20; and the magnification of an objective lens provided for the image-pickup optical system is changed. In this case, the slide glass sample-transporting device 21 for macro image acquisition and the slide glass sample macro-pickup device 22 can be omitted.

### Constitution of Slide Glass Sample-Holding Part

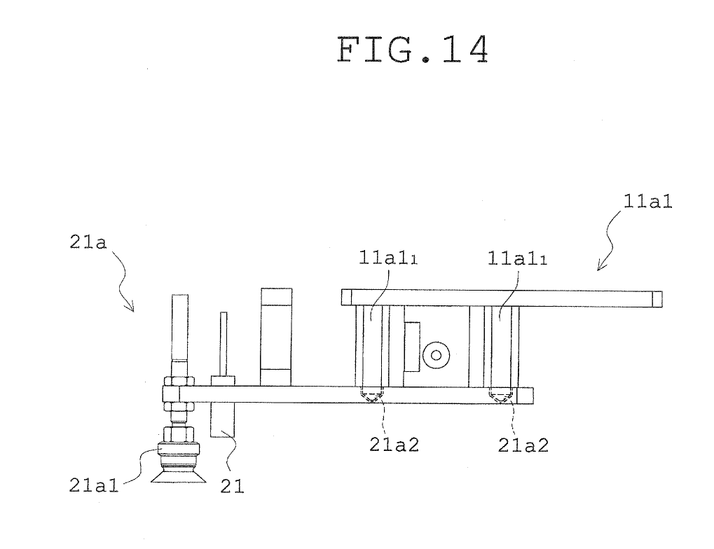

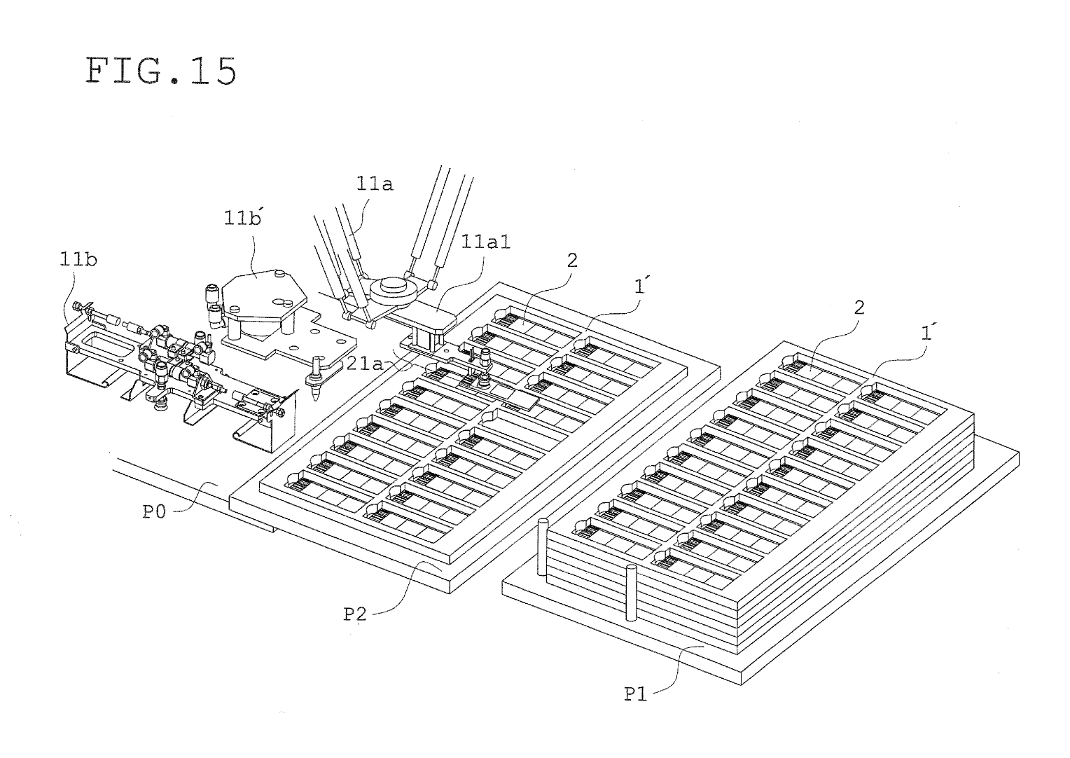

FIG. 13 is a perspective view showing one example of constitutions for a slide glass sample-holding part which is provided for a slide glass sample—transporting device for macro image acquisition in the microscopic image pickup apparatus of the present embodiment. FIG. 14 is an explanatory view showing a state in which the slide glass sample-holding part shown in FIG. 13 is fitted to the top end part of an articulated arm. FIG. 15 is an explanatory view showing a situation where: a slide glass sample is held and is transported by the slide glass sample-holding part shown in FIG. 13, the slide glass sample-holding part being fitted to the top end part of the articulated arm provided for the slide glass sample-transporting device for macro image acquisition in the microscopic image pickup apparatus of the present embodiment. Besides, the numerical number 2 in FIG. 13 denotes slide glass sample, the numerical number 2a in FIG. 13 denotes a specimen area on a slide glass sample (that is, an area covered with a cover glass), and the numerical number 2b in FIG. 13 denotes identifier which is put on a slide glass sample and is like bar code.

The slide glass sample-holding part 21a shown in FIG. 13 includes a slide glass sample-adhering part 21a1 and a third adhesion groove 21a2.

The slide glass sample-adhering part 21a1 is formed in such a way that: the slide glass sample-adhering part 21a1 can adhere to a predetermined area of the slide glass sample 2 which is different from the specimen area 2a on the slide glass sample 2; and the slide glass sample-adhering part 21a1 can release its adhesion to the predetermined area of the slide glass sample 2.

As shown in FIG. 14, while the top end of the adhering part 11a1₁ of the articulated arm 11 is being fitted into the third adhesion groove 21a2, the adhering part 11a1₁ adheres to the slide glass sample-holding part 21a and the adhering part 11a1₁ releases its adhesion to the slide glass sample-holding part 21a.

In addition, the slide glass sample-holding part 21a shown in FIG. 13 includes a slide glass sample hold position-detecting sensor 21a3.

The slide glass sample hold position-detecting sensor 21a3 consists of a fiber sensor or the like and is formed, for example, in such a way that, by detecting the identifier 2b stuck on the glass slide 2, the slide glass sample hold position-detecting sensor 21a3 can detect the predetermined area different from the specimen area 2a on the slide glass sample 2 as a part of the glass slide 2 which the slide glass sample-adhering part 21a1 adherers to.

As described above, the articulated arm 11a is formed in such a way that the top end part 11a1 of the articulated arm 11a can be removably fitted to different types of slide holder-holding parts 11b and 11b′ and to the slide glass sample-holding part 21a from above and automatically.

Besides, when the different types of slide holder-holding parts 11b and 11b′ and the slide glass sample-holding part 21a are not fitted to the top end part 11a1 of the articulated arm 11a, the different types of slide holder-holding parts 11b and 11b′ and the slide glass sample-holding part 21a3 are arranged in a predetermined standby position P0 which are shown in FIG. 5, 6C, 10, 12, or 15, respectively, for example.

### Schematic Constitution of Slide Glass Sample Micro-Pickup Section

The slide glass sample micro-pickup section 30 is composed of a slide glass sample-transporting device 31 for micro image acquisition and a slide glass sample micro-pickup device 32.

The slide glass sample micro-pickup device 32 consists of a so-called virtual slide microscope imaging device and is formed in such a way that: the slide glass sample micro-pickup device 32 can divide an imaging part in a specimen area on a slide glass sample into small sections under predetermined imaging conditions (imaging magnification and microscopy) which are set through a screen display-controlling device 41 described below; and the slide glass sample micro-pickup device 32 can acquire the image of each of the small divided sections with a high resolution in order to acquire a micro image of the specimen area on the slide glass sample.

The slide glass sample-transporting device 31 for micro image acquisition is formed in such a way that: the slide glass sample-transporting device 31 includes a publically-known XYZ stage (which is omitted in the drawings), for example; the slide glass sample-transporting device 31 can perform a third transportation operation in which the slide glass sample-transporting device 31 transports to the position in which the images of slide glass samples are acquired by the slide glass sample micro-pickup device 32 a slide glass sample located in the position in which the images of slide glass samples are acquired by the slide glass sample macro-pickup device 22; and the slide glass sample-transporting device 31 can perform a fourth transportation operation in which the slide glass sample-transporting device 31 transports to the position in which the images of slide glass samples are acquired by the slide glass sample macro-pickup device 22 a slide glass sample located in the position in which the images of slide glass samples are acquired by the slide glass sample micro-pickup device 32.

### Schematic Constitution of Imaging Process Control Section

The imaging process control section 40 includes a screen display control section 41 and a pickup control section 42, as shown in FIG. 4.

### Constitution of Screen Display Control Section

The screen display control section 41 generates a slide glass sample information management screen 41a for displaying slide glass sample information on a monitor connected to the imaging process control section 40, a slide holder whole image-displaying screen 41b, an imaging condition-setting screen 41c, a micro image-displaying screen 41d, a command screen 41e for commanding the apparatus to perform a predetermined imaging process and to display predetermined screens, a progress state-displaying screen 41f, and so on.

### Constitution of Slide Glass Sample Information Management Screen

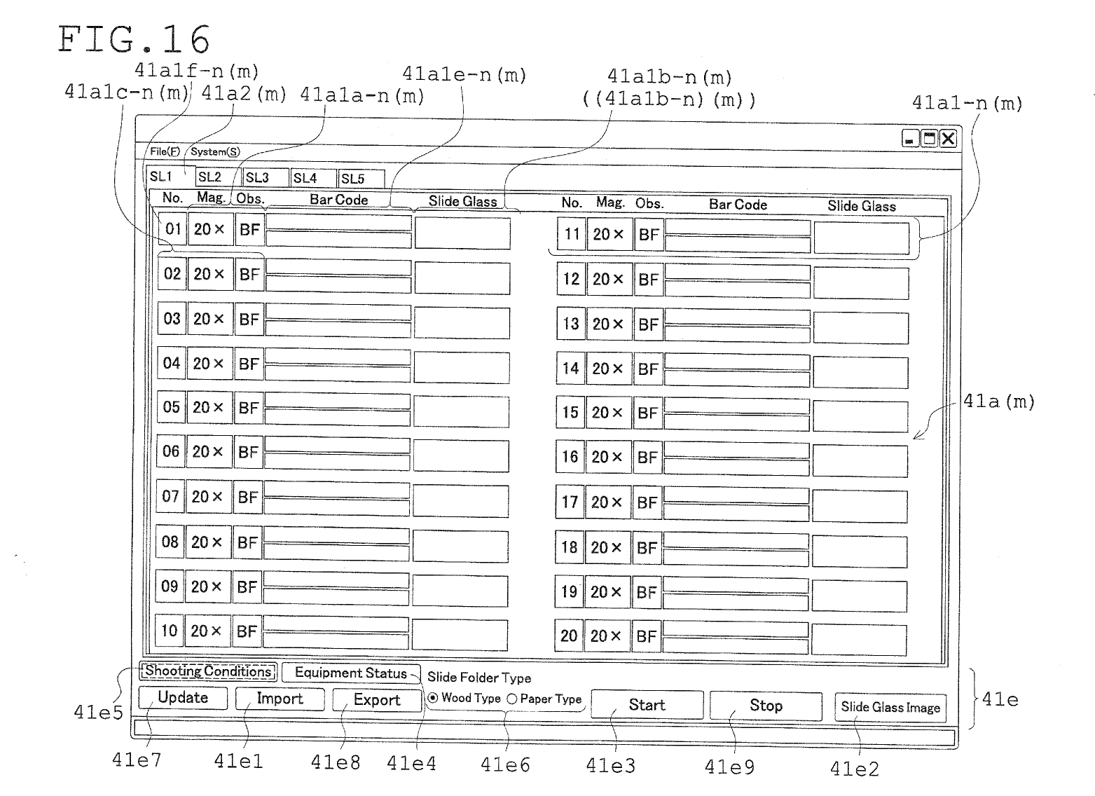

FIG. 16 is an explanatory view showing the structures of a slide glass samples information management screen and a command screen, these screens being provided for the screen display control section of the microscopic image pickup apparatus of the present embodiment.

As shown in FIG. 16, the slide glass sample information management screen 41a is provided with slide glass sample information-displaying areas 41a1-n (where n is a natural number which corresponds to the maximum number of slide glass samples capable of being arrayed on the slide holder) while the array of the slide glass sample information-displaying areas 41a1-n is being paralleled with the array of slide glass samples on the slide holder.

The slide glass sample information-displaying areas 41a1-n include micro imaging condition-displaying areas 41a1a-n for displaying imaging conditions for micro images of slide glass samples on a slide holder (imaging magnification and microscopy), slide glass sample whole image-displaying areas 41a1b-n for displaying the image of the whole of a slide glass sample, imaging condition setting screen-displaying tabs 41a1c-n for displaying a screen for setting imaging conditions, and micro image display switch tabs 41a1d-n for switching a displayed screen to a slide glass sample micro image-displaying screen, respectively. In addition, the slide glass sample information-displaying areas 41a1-n further include display areas 41a1e-n for displaying information for identifying slide glass samples, respectively. Besides, the reference numeral 41a1f-n in FIG. 16 denotes display areas for displaying the arrangement numbers of slide glass samples on a slide holder.

The imaging condition setting screen-displaying tabs 41a1c-n are formed in such a way that the imaging condition-setting screen 41c shown in FIG. 18 can be displayed by clicking one of the imaging condition setting screen-displaying tabs 41a1c-n.

Besides, the display areas 41a1f-n or the display areas 41a1a-n also function as the imaging condition setting screen-displaying tabs 41a1c-n in the example shown in FIG. 16. Accordingly, one of or both of the display areas 41a1f-n or the display areas 41a1a-n and the imaging condition setting screen-displaying tabs 41a1c-n can be also used as an imaging condition-setting means.

The micro image display switch tabs 41a1d-n are formed in such a way that a displayed screen can be switched to the micro image-displaying screen 41d by clicking the micro image display switch tabs 41a1d-n so that the micro image-displaying screen 41d is displayed.

Besides, the display areas 41a1b-n also function as the micro image display switch tabs 41a1d-n in the example shown in FIG. 16.

Also, in the example shown in FIG. 16, the display areas 41a1b-n also plays a role as switching a displayed screen in accordance with a stage of an imaging process for a slide glass sample so that: the image of the whole of the slide glass sample is displayed when the image of the whole of the slide glass sample is acquired; and the image of the whole of a specimen area of the slide glass sample is displayed after a micro image of the specimen area is acquired.

### Constitution of Slide Holder Whole Image-Displaying Screen

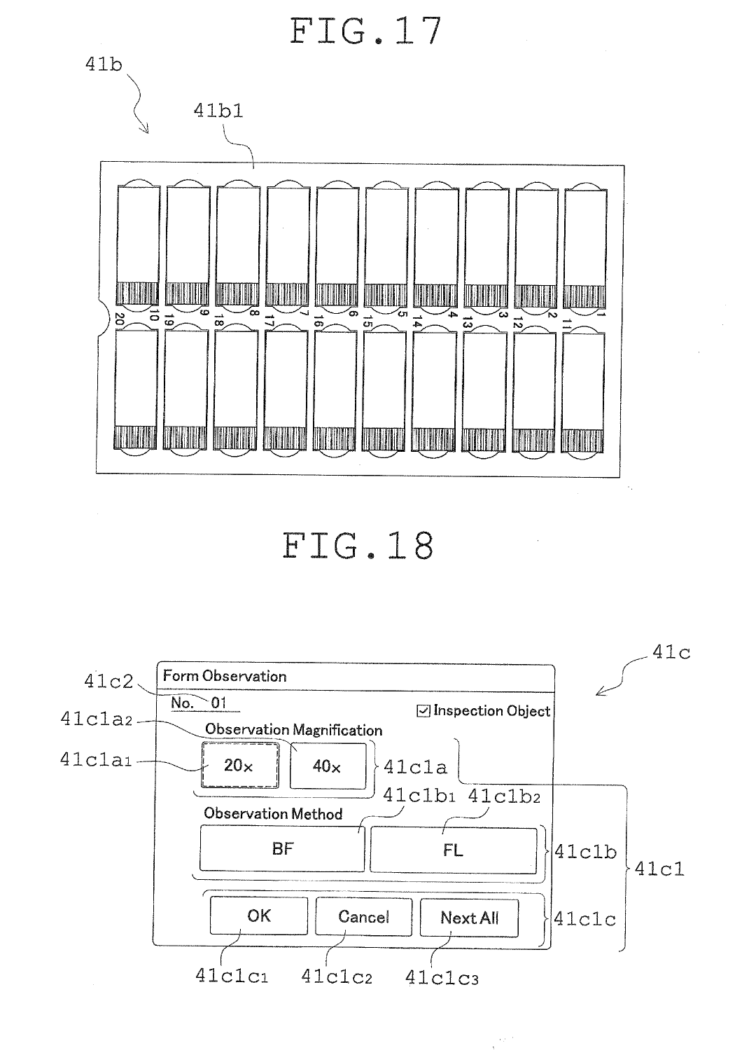

FIG. 17 is an explanatory view showing the structure of a screen for displaying the image of the whole of a slide holder, the screen being provided for the screen display control section of the microscopic image pickup apparatus of the present embodiment.

As shown in FIG. 17, the slide holder whole image-displaying screen 41b is provided with a display area 41b1 for displaying the whole images of slide glass samples. Besides, the image of the whole of a paper slide holder on which slide glass samples are arrayed is displayed on the display area 41b1 in the example shown in FIG. 17.

### Constitution of Imaging Condition-Setting Screen

FIG. 18 is an explanatory view showing the structure of an imaging condition-setting screen for setting imaging conditions, the imaging condition-setting screen being provided for the screen display control section of the microscopic image pickup apparatus of the present embodiment.

As shown in FIG. 18, the imaging condition-setting screen 41c is provided with a setting area 41c1 for setting imaging conditions for a micro image in a predetermined slide glass sample (imaging magnification and microscopy). Besides, the numerical reference 41c2 in FIG. 18 denotes a display area for displaying the arrangement number of a slide glass sample for which imaging conditions are set.

The setting area 41c1 includes an area 41c1a for setting an imaging magnification, an area 41c1b for setting a microscopy, and command buttons 41c1c.

In the example shown in FIG. 18, the imaging magnification-setting area 41c1a includes selection buttons 41c1a₁ and 41c1a₂ through which a magnification of 20 or 40 can be selected. Also, the microscopy-setting area 41c1b includes selection buttons 41c1b₁ and 41c1b₂ through which one of a bright field observation and a fluorescence observation can be selected.

The command buttons 41c1c include a setting button 41c1e₁, a setting-cancelling button 41c1c₂, and an all setting button 41c1c₃.

The setting contents which are set on the imaging magnification-setting area 41c1a and the microscopy-setting area 41c1b are acquired into a storage unit which is not shown in the drawings, as imaging conditions for a slide glass sample the arrangement number of which is displayed on the display area 41c2, by clicking the setting button 41c1c₁. The contents which are set on the imaging magnification-setting area 41c1a and the microscopy-setting area 41c1b are initialized by clicking the setting-cancelling button 41c1c₂. The setting contents which are set on the imaging magnification-setting area 41c1a and the microscopy-setting area 41c1b are acquired into the storage unit which is not shown in the drawings, as imaging conditions for all the slide glass samples the arrangement numbers of which follow the arrangement number displayed on the display area 41c2 and which are arrayed on the slide holder, by clicking the all setting button 41c1c₃.

### Constitution of Micro Image-Displaying Screen

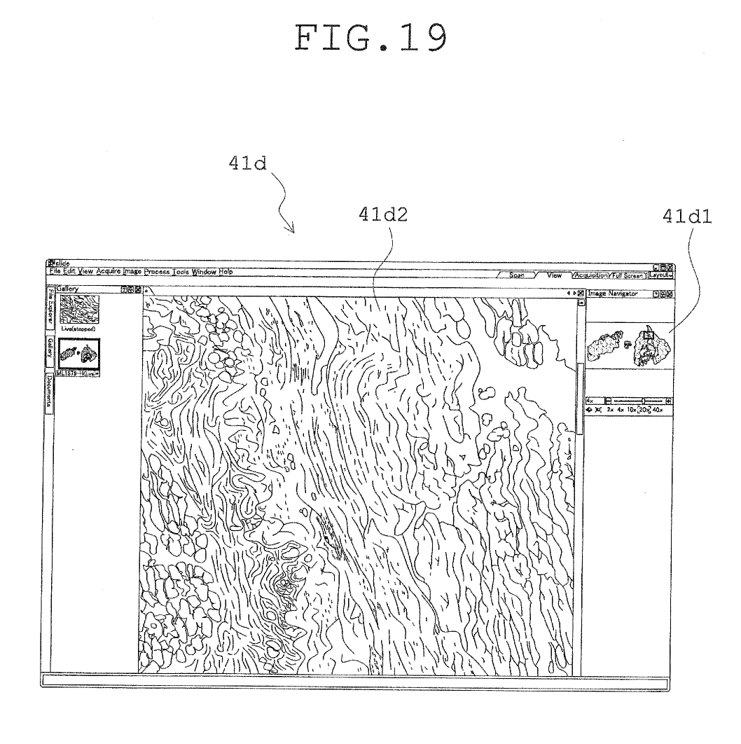

FIG. 19 is an explanatory view showing the structure of a micro image-displaying screen for displaying micro images, the micro image-displaying screen being provided for the screen display control section of the microscopic image pickup apparatus of the present embodiment.

As shown in FIG. 19, the micro image-displaying screen 41d includes: a setting area 41d1 for setting a desired part of a specimen area in a slide glass sample so that the micro image of the desired part is displayed; and a display area 41d2 for enlarging and displaying the micro image of the desired part of the specimen area which is set through the setting area 41d1.

### Constitution of Command Screen

As shown in FIG. 16 for example, the command screen 41e includes a first imaging process command button 41e1, a switch tab 41e2 for switching a displayed screen to a screen displaying the image of the whole of a slide holder, a second imaging process command button 41e3, a switch tab 41e4 for switching a displayed screen to a screen displaying a progress state, a switch tab 41e5 for switching a displayed screen to a screen for managing information of slide glass samples, and a selection area 41e6 for selecting a type of slide holder (a paper slide holder or wooden slide holder).

The microscopic image pickup apparatus can be commanded to acquire the image of the whole of a slide holder by clicking the first imaging process command button 41e1.

The microscopic image pickup apparatus can be commanded to switch a displayed screen to the slide holder whole image-displaying screen 41b shown in FIG. 17 to display the screen 41b by clicking the switch tab 41e2.

The microscopic image pickup apparatus can be commanded to acquire the whole images of all the slide glass samples arrayed on a desired slide holder and micro images of specimen areas in all the slide glass samples on the desired slide holder, by clicking the second image process button 41e3.

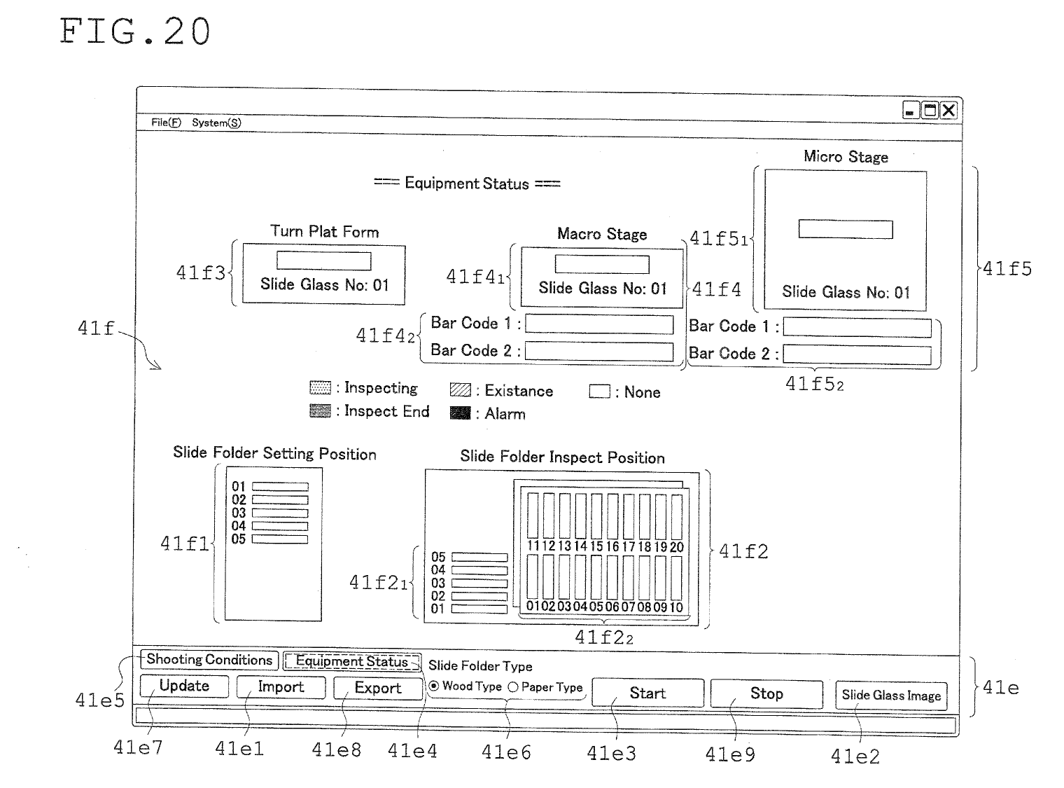

A displayed screen can be switched to the progress status-displaying screen 41f shown in FIG. 20 to display the screen 41f by clicking the switch tab 41e4.

A displayed screen can be switched to the slide glass sample information-management screen 41a shown in FIG. 16 to display the screen 41a by clicking the switch tab 41e5.

In addition, the command screen 41e includes an update command button 41e7, a first imaging process stop button 41e8, and a second imaging process stop button 41e9, in the example shown in FIG. 16.

The microscopic image pickup apparatus can be commanded to acquire the image of the whole of a slide holder afresh by clicking the update command button 41e7.

The microscopic image pickup apparatus can be commanded to stop an imaging process for acquiring the image of the whole of a slide holder by clicking the first imaging process stop button 41e8.

The microscopic image pickup apparatus can be commanded to stop imaging processes for acquiring the whole images of all the slide glass samples arrayed on a desired slide holder and for acquiring micro images of specimen areas in all the slide glass samples on the desired slide holder by clicking the second imaging process stop button 41e9.

### Constitution of Progress State-Displaying Screen

FIG. 20 is an explanatory view showing the structure of a progress state-displaying screen for displaying a progress state, the progress state-displaying screen being provided for the screen display control section of the microscopic image pickup apparatus of the present embodiment.

As shown in FIG. 20, the progress state-displaying screen 41f includes predetermined display areas for displaying progress states of the imaging processes for a slide holder and slide glass samples.

For a more detailed explanation of the progress state-displaying screen 41f, the progress state-displaying screen 41f includes: a display part 41f1 for displaying a progress state in the standby position of slide holders; a display part 41f2 for displaying a progress state in the position in which the images of slide holders are acquired; a display part 41f3 for displaying a progress state in the position of a rotation table 21b described below; a display part 41f4 for displaying a progress state in the position in which the macro images of slide glass samples are acquired; and a display part 41f5 for displaying a progress state in the position in which the micro images of slide glass samples are acquired.

A state of slide holders stacked in the standby position can be displayed on the display part 41f1 for displaying a progress state in the standby position of slide holders, for example, through predetermined identifiers such as colors.

In this case, the display part 41f1 includes a slide holder number-displaying area and a slide holder stack state-displaying area.

Numbers corresponding to the number of slide holders which are located in the standby position and counted by a slide holder-counting device 51 described below are displayed as consecutive numbers on the slide holder number-displaying area in such a way that a slide holder located at the highest position is given a number “1”. States of the respectively numbered slide holders existing or not existing in the standby position are displayed with colors on the slide holder stack state-displaying area.

A progress state of transportation of slide holders to the position in which the images of slide holders are acquired by the slide holder pickup device 12 and a progress state of the processes of slide glass samples put on the transported slide holders respectively can be displayed on the display part 41f2 for displaying a progress state in the position in which the images of slide holders are acquired, for example, through predetermined identifiers such as colors.

In this case, the display part 41f2 includes a display area 41f2₁ and a display area 41f2₂.

The display area 41f2₁ includes a slide holder number-displaying area 41f2₁ₐ and a slide holder stack state-displaying area 41f2_{1b}.

Numbers corresponding to the number of slide holders which are transported to the position in which the images of slide holders are acquired by the slide holder pickup device 12 are displayed as consecutive numbers on the slide holder number-displaying area 41f2₁ₐ in such a way that a slide holder located at the lowest position is given a number “1”. States of the respectively numbered slide holders existing or not existing in the position in which the images of slide holders are acquired by the slide holder pickup device 12 are displayed with colors on the slide holder hold state-displaying area 41f2_{1b}.

The display area 41f2₂ includes a slide glass sample number-displaying area 41f2₂ₐ and a slide glass sample process sate-displaying area 41f2_{2b}.

Numbers corresponding to the number of slide glass samples arrayed on a slide holder which is transported to the position in which the images of slide holders are acquired by the slide holder pickup device 12 are displayed on the slide glass sample number-displaying area 41f2₂ₐ as consecutive numbers in such a way that the array of these numbers is paralleled with the array of the slide glass samples on the slide holder, like the display areas 41a1f-n shown in FIG. 16.

The present states of the imaging processes of the respective numbered slide glass samples (such as a state of a slide glass sample being under imaging process, a state of the imaging process of a slide glass sample being complete, and a state of a slide glass sample existing or not existing on a slide holder) are displayed on the slide glass sample process state-displaying area 41f2_{1b}, with colors.

A progress state of transportation of slide glass samples to the position of the rotation table 21b can be displayed on the display part 41f3 for displaying the progress state in the position of the rotation table 21b, through predetermined identifiers such as colors.

In this case, the display part 41f3 includes a slide glass sample number-displaying area and a slide glass sample process state-displaying area.

The number of a slide glass sample which becomes an object of imaging process now is displayed on the slide glass sample number-displaying area.

States of slide glass samples existing or not existing in the position of the rotation table 21b are displayed on the slide glass sample process state-displaying area, with colors.

A progress state of transportation of slide glass samples to the position in which the images of slide glass samples are acquired by the slide glass sample macro-pickup device 22 can be displayed on the display part 41f4 for displaying a progress state in the position in which the macro images of slide glass samples are acquired, through predetermined identifiers such as colors. In addition, the identification information of slide glass samples can be also displayed on the display part 41f4.

In this case, the display part 41f4 includes a slide glass sample number-displaying area 41f4₁, a slide glass sample process state-displaying area 41f4₂, and a slide glass sample identification information-displaying area.

The number of a slide glass sample which becomes an object of imaging process now is displayed on the slide glass sample number-displaying area 41f4₁.

States of slide glass samples existing or not existing in the position in which the macro images of slide glass samples are acquired by the slide glass sample macro-pickup device 22 are displayed on the slide glass sample process state-displaying area 41f4₂, with colors.

The identification information of a slide glass sample detected by a slide glass sample identification information-detecting device 52 is displayed on the slide glass sample identification information-displaying area 41f4₃ when the slide glass sample is transported to the position in which the macro images of slide glass samples are acquired by the slide glass sample macro-pickup device 22.

States of transported slide glass samples existing or not existing in the position in which the micro images of slide glass samples are acquired by the slide glass sample micro-pickup device 32 can be displayed on the display part 41f5 for displaying a progress state in the position in which the micro images of slide glass samples are acquired, through predetermined identifiers such as colors. In addition, the identification information of slide glass samples can be also displayed on the display part 41f5.

In this case, the display part 41f5 includes a slide glass sample number-displaying area 41f5₁, a slide glass sample process state-displaying area 41f5₂, and a slide glass sample identification information-displaying area.

The number of a slide glass sample which becomes an object of imaging process now is displayed on the slide glass sample number-displaying area 41f5₁.

States of slide glass samples existing or not existing in the position in which the macro images of slide glass samples are acquired by the slide glass sample micro-pickup device 32 are displayed on the slide glass sample process state-displaying area 41f5₂, with colors.

The identification information of a slide glass sample detected by the slide glass sample identification information-detecting device 52 (refer to FIG. 4) is displayed on the slide glass sample identification information-displaying area when the slide glass sample is transported to the position in which the micro images of slide glass samples are acquired by the slide glass sample micro-pickup device 32.

Besides, the slide holder stack state-displaying area and the slide glass sample process state-displaying areas 41f4₂ and 41f5₂ are constructed so as to display an error message in the form of a color, when an error in transportation of or in the imaging process for a slide holder or a slide glass sample occurs.

### Constitution of Pickup Control Section

A pickup control section 42 is composed of a central processing unit of a personal computer or the like. The pickup control section 42 includes an initial display-controlling unit 42a, a first image acquisition mechanism drive-controlling unit 42b, and a second image acquisition mechanism drive-controlling unit 42c.

The initial display-controlling unit 42a functions as a unit initializing both the slide glass sample information management screen 41a and the command screen 41e into their opening screens respectively.

The first image acquisition mechanism drive-controlling unit 42b functions as a unit performing control on driving of a mechanism for acquiring the images of slide holders for all the slide holders in turn when the first imaging process command button 41e1 is clicked.

The control on driving of the mechanism for acquiring the images of slide holders is as follows. The slide holder-transporting device 11 is driven by the first image acquisition mechanism drive-controlling unit 42b so that the first transportation operation is performed, and the slide holder pickup device 12 is next driven by the first image acquisition mechanism drive-controlling unit 42b so that the image of the whole of a slide holder is acquired.

The second image acquisition mechanism drive-controlling unit 42c functions as a unit performing control on driving of a mechanism for acquiring the images of slide glass samples and control on driving of a mechanism for exchanging one slide holder for another one with respect to one slide holder when the second imaging process command button 41e3 is clicked.

The control on driving of the mechanism for acquiring the images of slide glass samples is as follows. The slide glass sample-transporting device 21 for macro image acquisition is driven by the second image acquisition mechanism drive-controlling unit 42c so that the second transportation operation is performed, the slide glass sample macro-pickup device 22 is next driven by the second image acquisition mechanism drive-controlling unit 42c so that the image of the whole of a slide glass sample is acquired, the slide glass sample-transporting device 31 for micro image acquisition is next driven by the second image acquisition mechanism drive-controlling unit 42c so that the third transportation operation is performed, the slide glass sample micro-pickup device 32 is next driven by the second image acquisition mechanism drive-controlling unit 42c so that a micro image of a specimen area on the slide glass sample is acquired, the slide glass sample-transporting device 31 for micro image acquisition is next driven by the second image acquisition mechanism drive-controlling unit 42c so that the fourth transportation operation is performed, and the slide glass sample-transporting device 21 for macro image acquisition is next driven by the second image acquisition mechanism drive-controlling unit 42c so that the fifth transportation operation is performed. This control on driving of the mechanism for acquiring the images of slide glass samples is performed for all the slide glass samples arrayed on a slide holder, in turn.

Also, the control on driving of the mechanism for exchanging one slide holder for another one is performed in such a way that, after control on driving of the mechanism for acquiring the images of slide glass samples is complete with respect to all the slide glass samples arrayed on one slide holder, the slide holder-transporting device 11 is driven by the second image acquisition mechanism drive-controlling unit 42c so that the sixth transportation operation is performed.

### Another Constitution of Pickup Control Section

Besides, in the microscopic image pickup apparatus of the present embodiment, the pickup control section 42 further includes a third image acquisition mechanism drive-controlling unit, a fourth image acquisition mechanism drive-controlling unit, and a fifth image acquisition mechanism drive-controlling unit.

When the update command button 41e7 is clicked, the third image acquisition mechanism drive-controlling unit performs control on driving of the mechanism for acquiring the images of slide holders with respect to all the slide holders in turn, and then the image of the whole of a slide holder which is acquired by the just previous control on driving of the mechanism for acquiring the images of slide holders and stored in the predetermined storage unit not shown in the drawing is replaced with the newest image of the whole of a slide holder which is acquired the latest by driving the slide holder pickup device 12, by the third image acquisition mechanism drive-controlling unit.

When the first image process-stopping button 41e8 is clicked, the fourth image acquisition mechanism drive-controlling unit stops control on driving of the mechanism for acquiring the images of slide holders and triggers the slide holder-transporting device 11 so that the sixth transportation operation is performed with respect to all of slide holders which have been transported to the position in which the images of slide holders are acquired by the slide holder pickup device 12, in the stop of the control on driving of the mechanism for acquiring the image of slide holders.

When the second image process-stopping button 41e9 is clicked, the fifth image acquisition mechanism drive-controlling unit stops control on driving of the mechanism for acquiring the images of slide glass samples. And, when there is a slide glass sample which has been processed through the slide glass sample micro-pickup section 30 in the stop of the control on driving of the mechanism for acquiring the images of slide glass samples, the fifth image acquisition mechanism drive-controlling unit triggers the slide glass sample-transporting device 31 for micro image acquisition so that the fourth transportation operation is performed with respect to the slide glass sample which has been processed by the slide glass sample micro-pickup section 30, and then the fifth image acquisition mechanism drive-controlling unit next triggers the slide glass sample-transporting device 21 for macro image acquisition so that the fifth transportation operation is performed. Alternatively, when there is a slide glass sample which has been processed through the slide glass sample macro-pickup section 20 in the stop of the control on driving of the mechanism for acquiring the images of slide glass samples, the fifth image acquisition mechanism drive-controlling unit triggers the slide glass sample-transporting device 21 for macro image acquisition so that the fifth transportation operation is performed with respect to the slide glass sample which has been processed by the slide glass sample macro-pickup section 20.

Besides, the pickup control section 42 is connected to a predetermined storage unit in which images acquired by the slide holder pickup device 12, the slide glass sample macro-pickup device 22, and the slide glass sample micro-pickup device 32 respectively are stored. And, the pickup control section 42 functions as a unit which takes respective images acquired by these pickup devices from the storage unit so that the images are displayed on the corresponding areas on the slide glass sample information management screen 41a, the slide glass sample whole image-displaying screen 41b, and the slide glass sample micro image-displaying screen 41d in the screen display input device 41, respectively.

Also, each of the first image acquisition mechanism drive-controlling unit 42b and the second image acquisition mechanism drive-controlling unit 42c functions as a unit which makes the top end part 11a1 of the articulated arm 11a automatically adhere to the slide holder-holding part 11b (or 11b′) selected through the selection area 41e6 or automatically release its adhesion to the slide holder-holding part 1b (or 1b′) and which makes the top end part 11a1 of the articulated arm 11a automatically adhere to the slide glass sample-holding part 21a or automatically release its adhesion to the slide glass sample-holding part 2a, when these mechanisms for acquiring images are driven.

### Constitutions of Another Parts of Apparatus (Constitutions of Rotation Table and Slide Glass Sample Arrangement Direction-Checking Part)

Besides, in the microscopic image pickup apparatus of the present embodiment, the slide glass sample-transporting device 21 for macro image acquisition further includes the rotation table 21b, a slide glass sample arrangement direction-checking part 21c, and the publically-known XYZ-stage (which is omitted in the drawings).

The rotation table 21b is placed short of the position in which the micro images of slide glass samples are acquired by the slide glass sample macro-pickup device 22. The slide glass sample arrangement direction-checking part 21c is formed in such a way that the slide glass sample arrangement direction-checking part 21c judges whether a slide glass sample transported to the position of the rotation table 21b is arranged while facing a predetermined direction or not, for example, by detecting the position of the bar code on the slide glass sample. In the case where a slide glass sample transported to the position of the rotation table 21b is arranged while facing the direction opposite to the predetermined direction which the slide glass sample should face, the rotation table 21b is rotated so that the slide glass sample is arranged while facing the predetermined direction.

The publically-known XYZ-stage (which is omitted in the drawings) is formed in such a way that a slide glass sample transported to the position of the rotation table 21b and arranged while facing the predetermined direction can be transported to the position in which the images of slide glass samples are acquired by the slide glass sample macro-pickup device 22, by the XYZ-stage.

Besides, in an example of variations of the above constitution, the rotation table 21b may be placed at the position in which the images of slide glass samples are acquired by the slide glass sample macro-pickup device 22 so that the publically-known XYZ-stage is omitted.

Besides, instead of providing the slide glass sample-transporting device 21 with the slide glass sample arrangement direction-checking part 21c, microscopic image pickup apparatuses according to the present invention may be formed in such a way that: the slide glass sample information-displaying areas 41a1-n in the slide glass sample information management screen 41a are provided with command areas for manually commanding the microscopic image pickup apparatus to change a direction which an arranged slide glass sample faces; and a slide glass sample having a command to change a direction which the slide glass sample faces is made to face the predetermined direction by rotating the rotation table 21b. In order to judge whether a slide glass sample is arranged while facing the predetermined direction or not in this case, an operator can make the judgment by checking the image of the whole of a slide holder which is displayed on the slide holder whole image-displaying screen 41b.

Alternatively, instead of providing the slide glass sample-transporting device 21 with the slide glass sample arrangement direction-checking part 21c, the slide glass sample-transporting device 21 for macro image acquisition may be provided with a device which gives the whole image of a slide holder acquired by the slide holder pickup device 12 an image analysis to automatically detect a directions which each of slide glass samples faces and to automatically make a judgment on a direction which each of slide glass samples faces, and the rotation table 21b may be rotated as much as necessary in accordance with the judgment result through the device so that the slide glass sample is arranged while facing the predetermined direction.

### Another Constitutions of Apparatus (Constitutions of Slide Holder-Counting Device and Slide Glass Sample Identification Information-Detecting Device)

Also, the microscopic image pickup apparatus of the present embodiment further includes the slide holder-counting device 51 and the slide glass sample identification information-detecting device 52.

The slide holder-counting device 51 is formed in such a way that the number of slide holders stacked in a predetermined standby position can be automatically counted, for example, by detecting the thickness of stacked slide holders. Besides, in the microscopic image pickup apparatus of the present embodiment, the slide holder-counting device 51 counts the number of slide holders stacked in the predetermined position on the basis of the thickness of one slide holder the type of which is selected through the selection area 41e6 of the command screen 41e.

Besides, in the microscopic image pickup apparatus of the present embodiment, the number of slide holders may be manually set, for example, by inputting the number of the slide glasses into the microscopic image pickup apparatus on a screen.

The slide glass sample identification information-detecting device 52 is composed of, for example, a bar code-reading device. And, the slide glass sample identification information-detecting device 52 is formed in such a way that the identification information of a slide glass sample can be detected by reading a bar code put on a slide glass sample which is transported to the position in which the images of slide glass samples are acquired by the slide glass sample macro-pickup device 22.

Also, the image input display device 41 is formed in such a way that the image input display device 41 can further include slide glass sample information management screens 41a (m) the number of which corresponds to the number of slide holders counted by the slide holder-counting device.

Each of the slide glass sample information management screens 41a (m) the number of which corresponds to the number of slide holders includes a slide glass sample information management screen holder-switching tab 41a2 (m).

The slide glass sample information management screen holder-switching tabs 41a2 (m) are formed in such a way that a click of one of the slide glass sample information management screen holder-switching tab 41a2 (m) makes it possible to display on top a slide glass sample information management screen 41a (m) (where the letter “m” denotes a natural number which is 1 or is larger than 1) including the clicked one of the slide glass sample information management screen holder-switching tabs 41a2 (m).

Also, the initial display-controlling unit 42a is formed in such a way that the initial display-controlling unit 42a makes the image input display device 41 display the slide glass sample information management screens 41a (m) the number of which corresponds to the number of slide holders counted by the slide holder-counting device 51 while the slide glass sample information management screens 41a (m) are overlapping with one another, as an opening screen.

Also, the second image acquisition mechanism drive-controlling unit 42c not only triggers the slide glass macro-pickup device 22 so that the image of the whole of a slide glass sample is acquired but also triggers the slide glass sample identification information-detecting device 52 so that the identification information of the slide glass sample is detected, between the second transportation operation caused by the slide glass sample-transporting device 21 and the third trans transportation operation caused by the slide glass sample-transporting device 31.

Now, in the microscopic image pickup apparatus of the present embodiment, the first image acquisition mechanism drive-controlling unit 42b functions as a unit performing control on driving of the mechanism for acquiring the images of slide holders with respect to all the slide holders in turn, as described above. Accordingly, slide holders are inevitably stacked in the position in which the images of slide holders are acquired by the slide holder pickup device 12. When slide holders are stacked more and more, the height of stacked slide holders varies as often as one slide holder is put on another one, in the position in which the images of slide holders are acquired by the slide holder pickup device 12. As a result, image acquisition area and magnification vary. In particular, the top slide holder is remarkably different from the bottom slide holder in image acquisition area and magnification. Accordingly, it is preferred that the microscopic image pickup apparatus of the present embodiment is provided with a correction means for automatically correcting variations in image acquisition area and magnification which occur in accordance with the number of stacked slide holders. For a specific explanation of correct means, the whole of an optical system provided for the slide holder pickup device 12 may include a mechanism which moves while keeping a relative distance between the optical system and the top slide holder constant in accordance with the number of stacked slide holders, for example. Alternatively, a Z-stage may be placed in the position in which the images of slide holders are acquired by the slide holder pickup device 12 and the Z-stage may be controlled in such a way the Z-stage moves while keeping a relative distance between the Z-stage and the top slide holder constant in accordance with the number of stacked slide holders.

### Procedure for Acquiring Images of Slide Glass Samples

The procedure for acquiring the images of slide glass samples using the microscopic image pickup apparatus of the present embodiment having such a constitution is as follows.

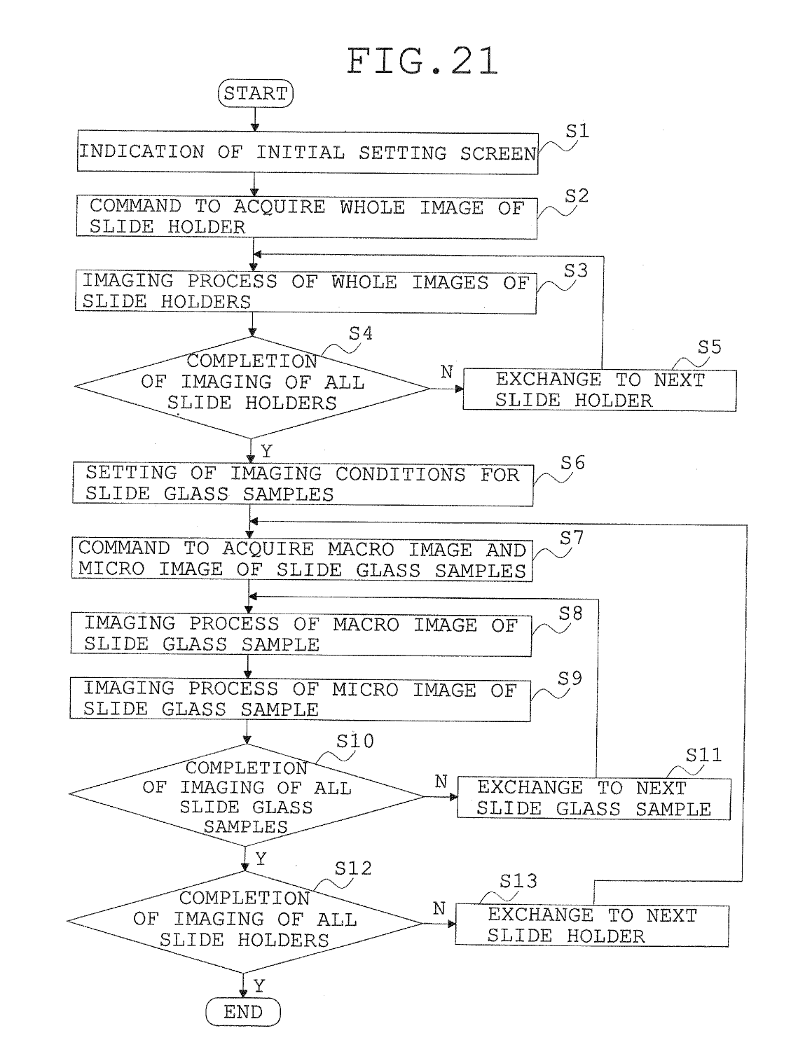

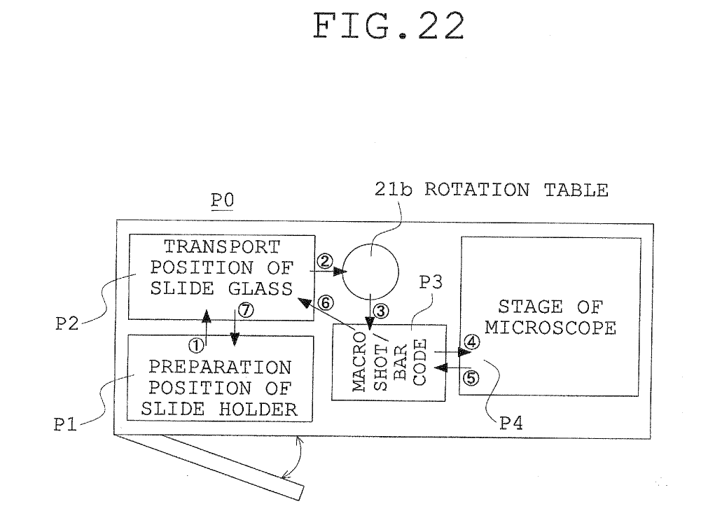

FIG. 21 is a flow chart showing a procedure for acquiring the image of a slide glass sample using the microscopic image pickup apparatus of the present embodiment. FIG. 22 is a block diagram schematically showing the relation between the positions of members which participate in transportation of a slide holder or a slide glass sample in the microscopic image pickup apparatus of the present embodiment.

In this case, slide holders of predetermined type are stacked in a predetermined standby position P1.

### Indication of Initial Setting Screen (Step S1)

The apparatus is switched on, and, for example, an initialization process is selected on a boot initialization screen which is not shown in the drawings. As a result, the initial display-controlling part 42a of the pickup control section 42 operates so that the slide glass sample information management screens 41a (m) the number of which corresponds to the number of slide holders counted by the slide holder-counting device 51 are displayed as an opening screen with the slide glass sample information management screens 41a (m) overlapping with one another (Step S1).

Besides, in the microscopic image pickup apparatus of the present embodiment, predetermined imaging conditions (imaging magnification and microscopy) in default settings are displayed on the display areas 41a1a-n (m) of the slide glass sample information management screens 41a (m). Also, in displaying the above described opening screen, the slide holder-counting device 51 counts the number of slide holders stacked in the predetermined standby position P1, on the basis of the thickness of one slide holder the type of which is set in the default settings. When an operator selects the type of slide holder on the selection area 41e6, the slide holder-counting device 51 counts the number of slide holders stacked in the predetermined standby position P1, on the basis of the thickness of one slide holder the type of which is selected through the selection area 41e6. And, the initial display-controlling part 42a of the pickup control section 42 makes the screen display control section 41 redisplay as an opening screen the slide glass sample information management screens 41a (m) the number of which corresponds to the number of slide holders counted by the slide holder-counting device 51 with the slide glass sample information management screens 41a (m) overlapping with one another.

### Command to Acquire Whole Image of Slide Holder (Step S2)

The operator clicks the first imaging process command button 41e1 after identifying the number of the slide holders through the slide glass sample information management screen holder-switching tabs 41a2 (m) (Step S2).

### Imaging Process of Whole Images of Slide Holders (Steps S3 to S5)

When the first imaging process command button 41e1 is clicked, the first image acquisition mechanism drive-controlling unit 42b of the pickup control section 42 triggers the slide holder pickup section 10 so that control on driving of the mechanism for acquiring the whole images of slide holders is performed for all the slide holders in turn (Steps S3 to S5).

### Details on Control on Driving of Mechanism for Acquiring Images of Slide Holders

The slide holder-transporting device 11 and the slide holder pickup device 12 are driven by control on driving of the mechanism for acquiring the images of slide holders in the following manner.

The top end part 11a1 of the articulated arm 11a is first made to move to be located above a slide holder-holding part 11b (or 11b′) the type of which is selected from the slide holder-holding parts 11b and 11b′ arranged in the predetermined standby position P0 on the selection area 41e6. Next, the articulated arm 11a moves the top end of the adhesion part 11a1₁ provided for the top end part 11a1 downward so that the top end of the adhesion part 11a1₁ is fitted into the first adhesion groove 11b3 (or the second adhesion groove 11b2′). The adhesion part 11a1₁ adheres to the slide holder-holding part 11b (or 11b′).

Next, the slide holder-transporting device 11 and the slide holder pickup device 12 perform the first transportation operation. Details on this are as follows. The articulated arm 11a moves the slide holder-holding part 11b (or 11b′) so that the slide holder-holding part 11b (or 11b′) is located above slide holders which are placed in the predetermined position P1. Next, the articulated arm 11a moves the slide holder-holding 11b (or 11b′) downward, and the slide holder-holding part 11b (or 11b′) holds a slide holder. Next, the articulated arm 11a moves the slide holder held by the slide holder-holding part 11b (or 11b′) so that the slide holder is located above the position P2 in which the images of slide holders are acquired by the slide holder pickup device 12. Next, the articulated arm 11a moves the slide holder-holding part 11b (or 11b′) downward and then the slide holder-holding part 11b (or 11b′) releases its hold of the slide holder. As a result, the first transportation operation made by the slide holder-transporting device 11 is complete, and the slide holder is placed in the position P2 in which the images of slide holders are acquired by the slide holder pickup device 12.

Next, the whole image of the slide holder is acquired by the slide holder pickup device 12.

### Setting of Imaging Conditions for Slide Glass Samples (Step S6)

Next, the operator sets imaging conditions in accordance with each of slide glass samples on the slide holder (Step S6).

### Details on Setting of Imaging Conditions

The details on setting of imaging conditions are as follows. A slide glass sample information-displaying area 41a1c-n (as which a display area 41a1f-n or 41a1a-n is also used in the example shown in FIG. 16) is clicked in each of the slide glass sample information-displaying areas 41a1-n in the slide glass sample information management screen 41a shown in FIG. 16, so that the imaging condition-setting screen 41c shown in FIG. 18 is displayed. And, after imaging magnification is selected on the imaging magnification setting area 41c1a and microscopy is selected on the microscopy-setting area 41c1b, the setting button 41c1c₁ is clicked (the all setting button 41c1c₃ is clicked in the case where all the slide glass samples having the arrangement numbers which follow the current arrangement number of the slide glass sample having given imaging conditions are given the same imaging conditions as the slide glass sample having the current arrangement number has given).

### Check on Whole Image of Slide Holder

Besides, the operator can check the acquired image of the whole of a slide holder whenever imaging conditions are set for each of slide glass samples on a slide holder.

The details on check on the whole image of a slide holder are as follows. The switch tab 41e2 for switching a displayed screen to a screen displaying the image of the whole of the slide holder is clicked. When the switch tab 41e2 is clicked, the slide holder whole image-displaying screen 41b is displayed. The operator can observe the image of the whole of the slide holder which is displayed on the display area 41b1 to check and/or verify whether each of slide glass samples to be arrayed on a slide holder exists on the slide holder or not, what direction each of the slide glass samples faces, or the like.

### Command to Acquire Macro and Micro Images of Slide Glass Sample (Step S7)

After the settings of imaging conditions for the respective slide glass samples on the slide holder are complete, the operator clicks the second imaging process command button 41e3 (Step S7).

### Imaging Process for Macro and Micro Images of Slide Glass Sample (Steps S8 to S13)

When the second imaging process command button 41e3 is clicked, the second image acquisition mechanism-driving unit 42c of the pickup control section 42 triggers the slide glass macro-pickup section 20, the slide glass sample micro-pickup section 30, and the slide holder pickup section 10 so that control on driving of the mechanism for acquiring the images of slide glass samples and control on driving of the mechanism for switching one slide holder to another one are performed with respect to one single slide holder (Steps S8 to S13).

### Details on Control on Driving of Mechanism for Acquiring Images of Slide Glass Samples

The slide glass sample-transporting device 21 for macro image acquisition, the slide glass sample macro-pickup device 22, the slide glass sample-transporting device 31 for micro image acquisition, and the slide glass sample micro-pickup device 32 are driven by control on driving of the mechanism for acquiring the images of slide glass samples, in the following manner.

First, the articulated arm 11a moves the slide holder-holding part 11b (or 11b′) so that the slide holder-holding part 11b (or 11b′) is located above the predetermined standby position P0. Next, after the articulated arm 11a moves the slide holder-holding part 11b (or 11b′) downward so that the slide holder-holding part 11b (or 11b′) is put on the predetermined standby position P0, the slide holder-holding part 11b (or 11b′) is released from the adhesion of the adhesion part 11a1₁ to the slide holder-holding part 11b (or 11b′), the adhesion part 11a1₁ being provided on the top end part 11a1. Next, the top end is moved upward by the articulated arm 11a, so that the top end of the adhesion part 11a1₁ provided on the top end part 11a1 is pulled out of the first adhesion groove 11b3 (or the second adhesion groove 11b2′).

Next, the articulated arm 11a moves the top end part 11a1 of the articulated arm 11a so that the top end part 11a1 is located above the slide glass sample-holding part 21a arranged in the predetermined position P0. Next, the articulated arm 11a moves the top end of the adhesion part 11a1₁ provided on the top end part 11a1 downward so that the top end of the adhesion part 11a1₁ is fitted into the third adhesion groove 21a2. And, the adhesion part 11a1₁ adheres to the slide glass sample-holding part 21a.

Next, the slide glass sample-transporting device 21 for macro image acquisition performs the second transportation operation. The details on the second transportation operation are as follows. The articulated arm 11a moves the slide glass sample-holding part 21a so that the slide glass sample-holding part 21a is located above a slide glass sample which is an object to be given an imaging process at this point in time, the slide glass sample being placed on the slide holder placed in the position P2 in which the images of slide holders are acquired by the slide holder pickup section 20. Next, the articulated arm 11a moves the slide glass sample-holding part 21a downward so that the slide glass sample-holding part 21a holds the slide glass sample. Next, the articulated arm 11a moves the slide glass sample held by the slide glass sample-holding part 21a so that the slide glass sample is located above the rotation table 21b provided short of the position P3 in which the images of slide glass samples are acquired by the slide glass sample macro-pickup device 22. Next, the articulated arm 11a moves the slide glass sample-holding part 21a downward, and then the slide glass sample-holding part 21a releases its hold of the slide glass sample. As a result, the slide glass sample is transported to the position of the rotation table 21b. Next, the slide glass sample arrangement direction-detecting unit 21c judges whether the slide glass sample is arranged while facing a predetermined direction or not. In the case where the result of the judgment made by the slide glass sample arrangement direction-detecting unit 21c shows that a direction which the slide glass sample faces is opposite to the predetermined direction, the rotation table 21c is rotated so that the slide glass sample faces the predetermined direction. Next, the publically-known XYZ-stage which is not shown in the drawings transports the slide glass sample transported to the position of the rotation table 21c and facing the predetermined direction, to the position P3 in which the macro images of slide glass samples are acquired by the slide glass sample macro-pickup device 22. As a result, the second transportation operation through the slide glass sample-transporting device 21 for macro image acquisition is complete.

Next, the slide glass sample macro-pickup device 22 acquires the image of the slide glass sample. Also, the slide glass sample identification information-detecting device 52 detects the identification information of the slide glass sample by reading a bar code put on the slide glass sample.

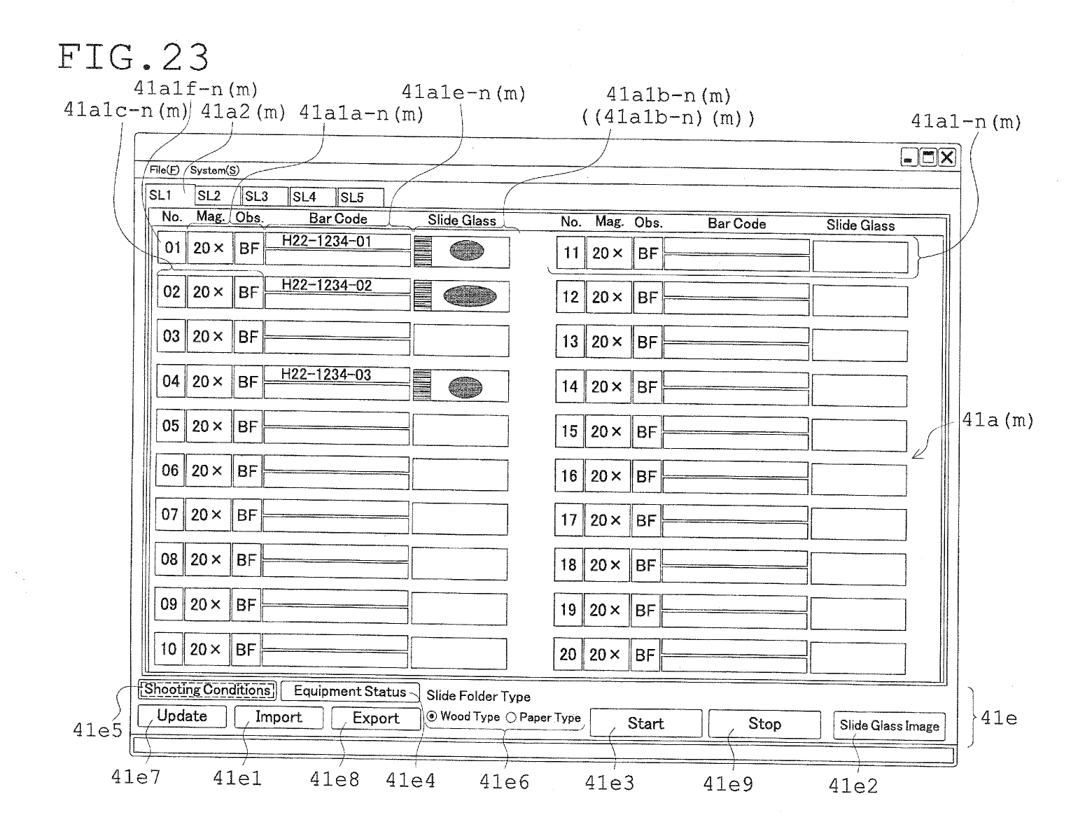

As shown in FIG. 23 for example, the image of the whole of the slide glass sample acquired by the slide glass sample macro-pickup device 22 and the identification information of the slide glass sample detected by the slide glass sample identification information-detecting device 52 are displayed on the display area 41a1e-n (m) and the display area 41a1b-n (m) in a slide glass sample information-displaying area 41a1-n (m) of a slide glass sample information management screen 41a (m), respectively.

Next, the slide glass sample-transporting device 31 for micro image acquisition transports the slide glass sample located in the position P3 in which the images of slide glass samples are acquired by the slide glass sample macro-pickup device 22, to the position P4 in which the images of slide glass samples are acquired by the slide glass sample micro-pickup device 32 (the third transportation operation).

Next, the slide glass sample micro-pickup device 32 acquires a micro image of a specimen area of the slide glass sample with imaging conditions for micro image (imaging magnification and microscopy) which have been set through the imaging condition-setting screen 41c.

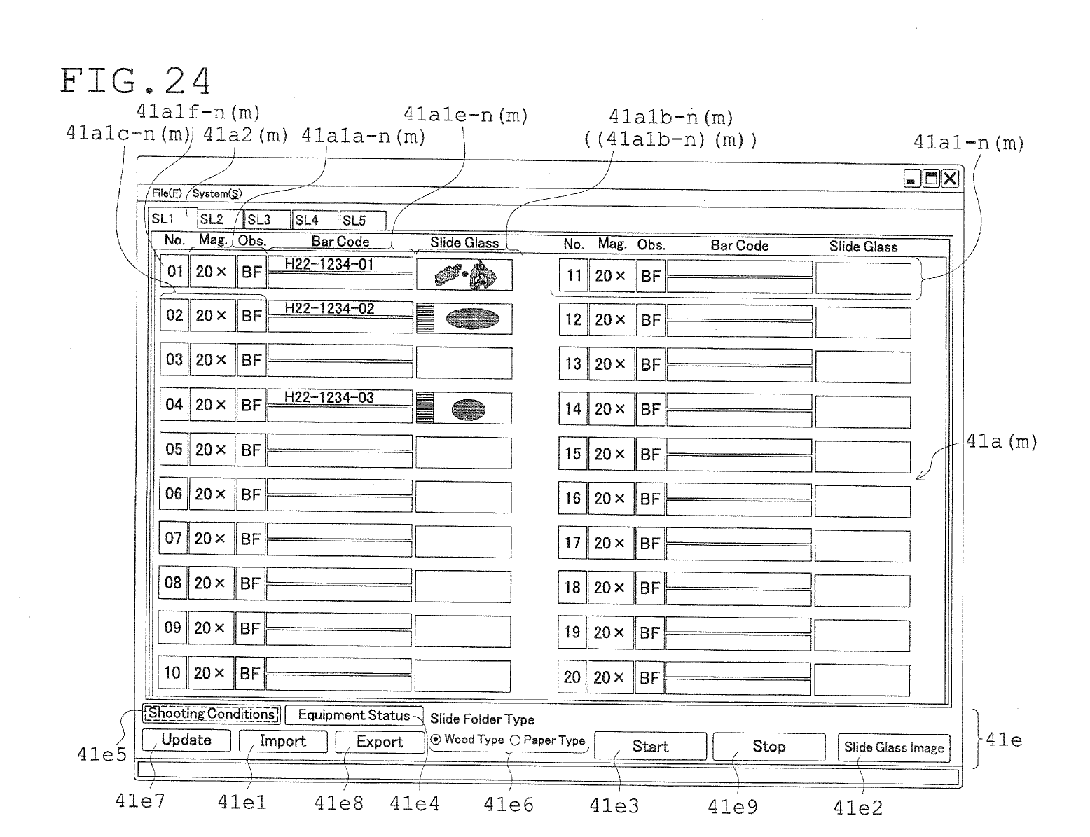

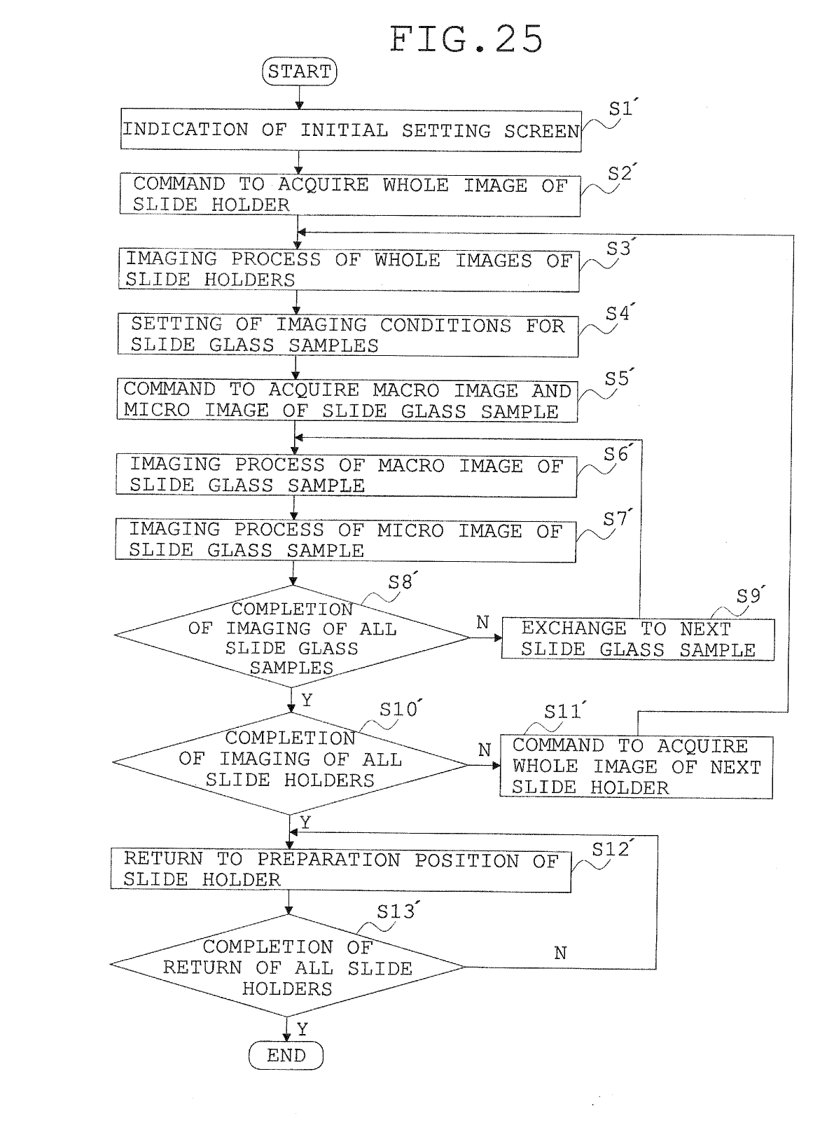

At this point, the image of the whole of the slide glass sample is displayed on the display area 41a1b-n (m) in the slide glass sample information-displaying area 41a1-n (m) of the slide glass sample information management screen 41a1 (m), as shown in FIG. 24.

Next, the slide glass sample-transporting device 31 for micro image acquisition transports the slide glass sample located in the position P4 in which the images of slide glass samples are acquired by the slide glass sample micro-pickup device 32, to the position P3 in which the images of slide glass samples are acquired by the slide glass sample macro-pickup device 22 (the fourth transportation operation).

Next, the slide glass sample-transporting device 21 for macro image acquisition performs the fifth transportation operation. The details on the fifth transportation operation are as follows. The articulated arm 11a moves the slide glass sample-holding part 21a so that the slide glass sample-holding part 21a is located above the slide glass sample located in the position P3 in which the images of slide glass samples are acquired by the slide glass sample macro-pickup device 22. Next, the articulated arm 11a moves the slide glass sample-holding part 21a downward, and then the slide glass sample-holding part 21a holds the slide glass sample. Next, the articulated arm 11a moves the slide glass sample held by the slide glass sample-holding part 21a so that the slide glass sample is located above the arrangement position of the slide glass sample on the slide holder, the slide glass sample currently becoming an object of imaging process and the slide holder being located in the position P2 in which the images of slide holders are acquired by the slide holder pickup device 12. Next, the articulated arm 11a moves the slide glass sample-holding part 21a downward, and then the slide glass sample-holding part 21a releases its hold of the slide glass sample.

This control on driving of the mechanism for acquiring the images of slide glass samples is performed with respect to all the slide glass samples which are arrayed on the slide holder, in turn.

### Details on Control on Driving of Mechanism for Switching One Slide Holder to Another One

The slide holder-transporting device 11 is driven by control on driving of the mechanism for switching one slide holder to another one, in the following manner.

First, the articulated arm 11a moves the slide glass sample-holding part 21a so that the slide glass sample-holding part 21a is located above the predetermined standby position P0. Next, after the articulated arm 11a moves the slide glass sample-holding part 21a downward so that the slide glass sample-holding part 21a is put on the predetermined standby position P0, the slide glass sample-holding part 21a is released from the adhesion of the adhesion part 11a1₁ to the slide glass sample-holding part 21a, the adhesion part 11a1₁ being provided on the top end part 11a1. Next, the top end is moved upward by the articulated arm 11a, so that the top end of the adhesion part 11a1₁ provided on the top end part 11a1 is pulled out of the third adhesion groove 21a1.

Next, the articulated arm 11a moves its top end part 11a1 so that the top end part 11a1 of the articulated arm 11a is located above the slide holder-holding part 11b (or 11b′) arranged in the predetermined standby position P0. Next, the articulated arm 11a moves the top end of the adhesion part 11a1₁ provided on the top end part 11a1, downward, so that the top end of the adhesion part 11a1₁ is fitted into the first adhesion groove 11b3 (or the second adhesion groove 11b2′). And, the adhesion part 11a1₁ adheres to the slide holder-holding part 11a (or 11b′).

Next, the articulated arm 11a moves the slide holder-holding part 11b (or 11b′) so that the slide holder-holding part 11b (or 11b′) is located above the slide holders stacked in the position P2 in which the images of slide holders are acquired by the slide holder pickup device 12. Next, the articulated arm 11a moves the slide holder-holding part 11b (11b′) downward so that the slide holder-holding part 11b (or 11b′) holds the slide holder. Next, the articulated arm 11a moves the slide holder held by the slide holder-holding part 11b (11b′) so that the slide holder is located above the predetermined standby position P1. Next, the articulated arm 11a moves the slide holder-holding part 11b (or 11b′) downward, and then the slide holder-holding part 11b (or 11b′) releases its hold of the slide holder.

As a result, the slide holder is put on the predetermined standby position P1, and the imaging process for slide glass samples arrayed on one slide holder is complete.

Afterward, the operator gives all the slide holders this imaging process for slide glass samples in turn by clicking the second imaging process command button 41e3.

Observation of Micro Image on Micro Image-Displaying Screen 41d after Process of Acquiring Micro Images of Slide Glass Samples

As described above, when the image of the whole of a slide glass sample is acquired, the image of the whole of the slide glass sample is displayed on a display area 41a1b-n (m) in a slide glass sample information-displaying area 41a1-n (m) of a slide glass sample information management screen 41a1 (m). And, after a micro image of a specimen area on the slide glass sample are acquired, the image of the whole of the specimen area on the slide glass sample is displayed on the display area 41a1b-n (m) in the slide glass sample information-displaying area 41a1-n (m) of the slide glass sample information management screen 41a1 (m).

At this point, the operator clicks the display area 41a1b-n (m) on which the image of the whole of the specimen area on the slide glass sample is displayed, so that the micro image-displaying screen 41d is displayed.

And, the operator sets a micro part of the specimen area on the slide glass sample the image of which the operator desires to display, through the setting area 41d1 in the micro image-displaying screen 41d. As a result, the image of the micro part of the specimen area which is set on the setting area 41d1 is displayed on the display area 41d2 while the image of the micro part of the specimen area is being enlarged.

### A State of Progress State-Displaying Screen Displayed in Imaging Processes for Slide Holders and Slide Glass Samples

Also, when the operator clicks the progress state display screen-switching tab 41e4 in imaging processes for slide holders and slide glass samples, the progress state-displaying screen 41f is displayed.

A state of slide holders being stacked in the predetermined standby position P1 is displayed on the slide holder standby position progress state-displaying part 41f1 of the progress state-displaying screen 41f while the top slide holder is being assigned a number 1 and slide holders located below the top slide holder are being assigned numbers as consecutive numbers in turn, in displaying the opening screen (Steps S1 and S2), for example.

Also, a state of slide holders being transported to and being stacked in the slide holder pickup section 12 imaging position P2 is displayed on the display area 41f2₁ of the slide holder imaging position progress state-displaying part 41f2 of the progress state-displaying screen 41f while the bottom slide holder is being assigned a number 1 and slide holders located above the bottom slide holder are being assigned numbers as consecutive numbers in turn in performing an imaging process for the whole images of slide holders (Step S4), for example. In addition, the indications for the slide holders transported to the position P2 on the slide holder standby position progress state-displaying part 41f1 are made to change from indication, “presence” to indication, “absence”.

Also, current states of processes for respective numbered slide glass samples (“under imaging process”, “the completion of imaging process”, or “presence” or “absence”) are displayed on the display area 41f2₂ of the slide holder imaging position progress state-displaying part 41f2 of the progress state-displaying screen 41f, in performing imaging processes for the macro and micro images of slide glass samples (Step S7), for example.

And, when a slide glass sample is located on the rotation table 21b, the presence of the slide glass sample on the rotation table 21b is shown on the slide glass sample processing state-displaying area 41f3₂ of the rotation table 21b position progress state-displaying part 41f3 of the progress state-displaying screen 41f, for example.

Also, when a slide glass sample is located in the position P3 in which the images of slide glass samples are acquired by the slide glass sample macro-pickup device 22, the presence of the slide glass sample in the slide glass sample macro-pickup device 22 imaging position P3 is shown on the slide glass sample macro image acquisition position slide glass sample processing state-displaying area 41f4₂ of the progress state-displaying screen 41f, for example. In addition, the identification information of the slide glass sample which is detected by the slide glass sample identification information-detecting device 52 is displayed on the slide glass sample identification information-displaying upper area 41f4₃ of the progress state-displaying screen 41f, for example.

Also, when a slide glass sample is located in the position P4 in which the images of slide glass samples are acquired by the slide glass sample micro-pickup device 32, the presence of the slide glass sample in the slide glass sample micro-pickup device 32 imaging position P4 is shown on the slide glass sample micro image acquisition position slide glass sample processing state-displaying area 41f5₂ of the progress state-displaying screen 41f, for example. In addition, the identification information of the slide glass sample which is detected by the slide glass sample identification information-detecting device 52 is displayed on the slide glass sample identification information-displaying upper area 41f5₃ of the progress state-displaying screen 41f, for example.

Besides, the microscopic image pickup apparatus of the present embodiment is formed in such a way that: the first image acquisition mechanism drive-controlling unit 42b continuously performs control on driving of the mechanism for acquiring the images of slide holders, with respect to all the slide holders 1 in turn; and then the second image acquisition mechanism drive-controlling unit 42c continuously performs control on driving of the mechanism for acquiring the images of slide glass samples with respect to all the slide glass samples arrayed on one slide holder 1. However, the present invention is not limited to such a constitution. For example, as one example of variations of the present embodiment, microscopic image pickup apparatuses according to the present invention may be formed in such a way that: the first image acquisition mechanism drive-controlling unit 42b performs control on driving of the mechanism for acquiring the images of slide holders with respect to a single slide holder 1; and then the second image acquisition mechanism drive-controlling unit 42c continuously performs a control of driving the mechanism for acquiring the images of slide glass samples with respect to all the slide glass samples 2 arrayed on the single slide holder 1. In this case, the microscopic image pickup apparatus may be formed in such a way that, after the second image acquisition mechanism drive-controlling unit 42c finishes performing control on driving of the mechanism for acquiring the images of all the slide glass samples 2 arrayed on one slide holder 1 with respect to all the slide holders 1, the slide holder-transporting device 11 is driven so that control on driving of a mechanism for returning slide holders to their original position to perform the sixth transportation operation is performed with respect to all the slide holders 1 in turn.

That is to say, the microscopic image pickup apparatus of the above example of variations of the present embodiment may be formed in such a way that control units (such as the first image acquisition mechanism drive-controlling unit 42b and the second image acquisition mechanism drive-controlling unit 42c) perform control on adhesion of the top end of the articulated arm 11a to plural kinds of the slide holder-holding parts 11b and 11b′ or on release of the slide holder-holding parts 11b and 11b′ from adhesion of the top end of the articulated arm 11a to plural kinds of the slide holder-holding parts 11b and 11b′ and control on adhesion of the top end of the articulated arm 11a to the slide glass sample-holding part 21a or on release of the slide glass sample-holding part 21a from adhesion of the top end of the articulated arm 11a to the slide glass sample-holding part 21a, respectively, in the following manners.

At the beginning of the first transportation operation for the slide holder 1 (or 1′) through the slide holder-transporting device 11, the first image acquisition mechanism drive-controlling unit 42b operates so that the top end of the articulated arm 11a is automatically fitted to the slide holder-holding part 11b (or 11b′) corresponding to a slide holder 1 (or 1′) the type of which is selected through a screen (the command screen 41e) having the selection area 41e6.

Also, at the beginning of the second transportation operation for the first slide glass sample 2 on the slide holder 1 (or 1′) through the slide glass sample-transporting device 21 for acquiring macro image, the second image acquisition mechanism drive-controlling unit 42c performs control so that the top end of the articulated arm 11a is automatically detached from the slide holder-holding part 11b (or 11b′), and then the second image acquisition mechanism drive-controlling unit 42c next operates so that the top end of the articulated arm 11a is automatically fitted to the slide glass sample-holding part 21a. And, after the completion of the fifth transportation operation for the last slide glass sample 2 on the slide holder 1 (or 1′), the second image acquisition mechanism drive-controlling unit 42c performs control so that the top end of the articulated arm 11a is automatically detached from the slide glass sample-holding part 21a.

In addition, at the beginning of the sixth transportation operation for the first slide holder 1 (or 1′) through the slide holder-transporting device 11, the second image acquisition mechanism drive-controlling unit 42c operates so that the top end of the articulated arm 11a is automatically fitted to the slide holder-holding part 11b (or 11b′). And, after the completion of the sixth transportation operation for the last slide holder 1 (or 1′), the second image acquisition mechanism drive-controlling unit 42c operates so that the top end of the articulated arm 11a is automatically detached from the slide holder-holding part 11b (or 11b′).

And, in this example of variations of the present embodiment, the images of slide glass samples 2 may be acquired according to the procedure shown in FIG. 22 (Steps S1′ to S13′).

### Effects of the Present Embodiment

The microscopic image pickup apparatus of the present embodiment is formed in such a way that: the microscopic image pickup apparatus includes a slide holder pickup section 10, a slide glass sample macro-pickup section 20, and a slide glass sample micro-pickup section 30; and acquiring the whole images of slide holders 1, acquiring the whole images of slide glass samples 2, acquiring micro images of specimen areas of the slide glass samples 2, displaying the acquired whole image of the slide holders 1, displaying the acquired whole images of the slide glass samples 2, or displaying the acquired micro image of the specimen areas 2a of the slide glass samples 2 can be performed through command means (such as the command buttons in the command screen 41e and the micro image screen display-switching tabs 41a1d-n), the command means being capable of be displayed together with the slide glass sample information management screen 41a including the slide glass sample information-displaying areas 41a1-n the array of which is paralleled with the array of the slide glass samples on each of slide holders 1. As a result, the settings for imaging conditions for respective slide glass samples 2, the image information of respective slide glass samples 2 the images of which are acquired, and so on can be verified while a state of the array of slide glass samples 2 arrayed on a slide holder 1 is being checked on a screen, by the slide holder which is managed in a hospital. In addition, the present embodiment makes it possible to prevent a wrong image acquisition due to confusions between one slide glass sample and another one and makes it possible to efficiently manage the information of slide glass samples 2.

Also, the microscopic image pickup apparatus of the present embodiment is formed in such a way that: the first image acquisition mechanism drive-controlling unit 42b continuously performs control on driving of the mechanism for acquiring the images of slide holders with respect to all the slide holders 1 in turn; and then the second image acquisition mechanism drive-controlling unit 42c continuously performs control on driving of the mechanism for acquiring the images of slide glass samples with respect to all the slide glass samples 2 arrayed on one slide holder 1, by the slide holder. As a result, imaging processes for the slide glass samples 2 are performed while a plurality of the slide holders 1 are being stacked in the position in which the images of slide holders are acquired by the slide holder pickup device 12, in the present embodiment, so that it is possible to reduce an amount of operation of transporting the slide holders 1 to the utmost and it is possible to efficiently acquire the images of slide glass samples 2 on each of a plurality of slide holders 1.

Also, the microscopic image pickup apparatus of the example of variations of the present embodiment is formed in such a way that: the first image acquisition mechanism drive-controlling unit 42b performs control on driving of the mechanism for acquiring the images of slide holders with respect to one slide holder 1; and then the second image acquisition mechanism drive-controlling unit 42c continuously performs control on driving of the mechanism for acquiring the images of slide glass samples with respect to all the slide glass samples 2 arrayed on the slide holder 1. As a result, the microscopic image pickup apparatus of the example of variations of the present embodiment operates in such a way that: imaging processes for the slide glass samples 2 are performed while a plurality of the slide holders 1 are being stacked in the position in which the images of slide holders are acquired by the slide holder pickup device 12; and, after all the imaging processes for all the slide glass samples 2 arrayed on one slide holder for all the slide holders 1 are complete, the slide holders 1 are continuously transported to the standby position for the slide holders 1, with a plurality of slide holders stacked in the position in which the images of slide holders are acquired by the slide holder pickup device 12. Accordingly, it is possible to reduce an amount of operation of transporting the slide holders 1 to the utmost and it is possible to efficiently acquire the images of slide glass samples 2 on each of a plurality of slide holders 1.

Also, the microscopic image pickup apparatus of the present embodiment includes a slide holder-transporting device 11, a slide glass sample-transporting device 21 for macro image acquisition, and a slide glass sample-transporting device 31 for micro image acquisition, so that while the microscopic image pickup apparatus of the present embodiment is requiring neither the transfer of slide glass samples 2 to a specific cartridge nor the use of slide holders having a special structure as in the apparatus disclosed in Japanese Patent TOKUKAI No. 2007-147399, and it is possible to acquire an micro images of slide glass samples 2 by using slide holders 1 generally used in hospitals as they are. Accordingly, unlike the apparatus disclosed in Japanese Patent TOKUKAI No. 2003-248176, the microscopic image pickup apparatus of the present embodiment can save operators from transferring slide glass samples between a slide holder and a cartridge, so that the mistake of putting slide glass samples at wrong positions does not occur when the slide glass samples are returned from a cartridge to a slide holder.

Also, the microscopic image pickup apparatus of the present embodiment is formed in such a way that: the microscopic image pickup apparatus includes the slide holder-counting device 51; the screen display control section 41 includes slide glass sample information management screens 41a (m) the number of which corresponds to the number of slide holders 1 counted by the slide holder-counting device 51; the slide glass sample information management screens 41a (m) the number of which corresponds to the number of the slide holders 1 include holder-switching tabs 41a2 (m) for switching one slide glass sample information management screen to another one to display another one on top; and the initial display-controlling unit 42a makes an opening screen in which slide glass sample information management screens 41a (m) the number of which corresponds to the number of the slide holders 1 counted by the slide holder-counting device 51 are displayed while the slide glass sample information management screens 41a (m) are overlapping with one another. As a result, the present embodiment makes it possible to verify the setting of imaging conditions for each of slide glass samples 2, the information of the acquired image of each of the slide glass samples 2, and so on with respect to a plurality of slide holders 1 on a screen. As a result, it is possible to efficiently manage the information of the slide glass samples 2 on a screen.

Also, the microscopic image pickup apparatus of the present embodiment is formed in such a way that: the microscopic image pickup apparatus includes the slide glass sample identification information-detecting device 52 which detects the identification information of slide glass samples 2; and each of the slide glass sample information-displaying areas 41a1-n (m) further include display areas 41a1e-n (m) for displaying the identification information of the slide glass samples 2. As a result, the present embodiment makes it possible to connect the information of patients including their medical histories with the information of the images of the slide glass samples 2, so that the present embodiment makes the management of the information of the slide glass samples 2 by the slide holder yet easier.

Also, the microscopic image pickup apparatus of the present embodiment is formed in such a way that: the screen input device 41 further includes the progress state-displaying screen 41f; and the command screen 41e includes the progress state display screen-switching tab 41e4 and the slide glass sample information management screen-switching tab 41e5. As a result, the present embodiment makes it possible for operators to grasp a progress state of an imaging process of the slide glass samples 2 by the slide holder and the positions of the slide holders 1 and the slide glass samples 2 at any time, so that the present embodiment makes it possible to more effectively manage imaging processes for the slide glass samples 2 by the slide holder.

Also, the microscopic image pickup apparatus of the present embodiment is formed in such a way that: the command screen 41e further includes the selection area 41e6 with which the type of slide holder 1 is selected; and the slide holder-counting device 51 counts the number of the slide holders 1 stacked on the predetermined standby position P1 on the basis of the thickness of one slide holder the type of which is selected on the selection area 41e6. As a result, the present embodiment makes it possible to verify the setting of imaging conditions for each of slide glass samples 2, the information of the acquired image of each of the slide glass samples 2, and so on with respect to a plurality of slide holders 1 on a screen, in accordance with different kinds of slide holders 1 which are different from one another in thickness. As a result, it is possible to yet more efficiently manage the information of the slide glass samples 2 on a screen.

Also, the glass slide transportation apparatus provided for the microscopic image pickup apparatus of the present embodiment is formed in such a way that: the slide holder-transporting device 11 includes an articulated arm 11a capable of moving in the three dimensional directions and plural kinds of slide holder-holding parts 11b and 11b′ capable of holding the slide holders 1 and 1′ and capable of releasing their holds of the slide holders 1 and 1′; the slide glass sample-transporting device 21 for acquiring macro image at least includes the articulated arm 11a and a slide glass sample-holding part 21a capable of holding a slide glass sample 2 and capable of releasing its hold of the slide glass sample 2; and the top end of each of the articulated arms 11a can be removably fitted to the slide holder-holding parts 11b and 11b′ or to the slide glass sample-holding part 21a. As a result, there is no necessity to provide the microscopic image pickup apparatus with plural kinds of slide holder-transporting devices 11 (or 11′) in accordance with the type of slide holder, so that it is possible to reduce a cost of slide holder-transporting device and a space for placing slide holder-transporting device the more. In addition, the present embodiment makes it possible to provide the slide holder-transporting device 11 (or 11′) and the slide glass sample-transporting device 21 with a common component (the articulated arm 11a), so that it is possible to restrain an increase in a space for placing the slide holder-transporting device 11 (or 11′) to the utmost, the increase being accompanied by the placement of the slide holder-transporting device 11 (or 11′). As a result, the present embodiment makes it possible to achieve a slide glass sample transportation apparatus used for microscopic image pickup apparatuses and capable of transporting different kinds of generally-used slide holders 1 and 1′ to the position in which the whole images of slide holders are acquired, with a cost of and a space for the placement of the slide glass sample transportation apparatus reduced to the utmost.

Also, the glass slide transportation apparatus provided for the microscopic image pickup apparatus of the present embodiment is formed in such a way that: the top end of the articulated arm 11a includes an adhesion part 11a1₁ capable of adhering to an object and capable of releasing adhesion of the adhesion part 11a1₁ to an object through magnetism or air; a paper slide holder-holding part 11b, a wooden slide holder-holding part 11b′, and a slide glass sample-holding part 21a include first, second, and third adhesion grooves 11b3, 11b2′, and 21a2 respectively; and the adhesion part 11a1₁ is made to adhesive to the first, second, or third adhesion groove 11b3, 11b2′, or 21a2 or made to release adhesion of the adhesion part 11a1₁ to the first, second, or third adhesion groove 11b3, 11b2′, or 21a2 while the adhesion part 11a1₁ is being fitted to the first, second, or third adhesion groove 11b3, 11b2′, or 21a2. As a result, the present embodiment makes it easy to removably fit the top end of the articulated arm 11a to each of different kinds of slide holder-holding parts 11b and 11b′ and the slide glass sample-holding part 21a.

Also, the glass slide transportation apparatus provided for the microscopic image pickup apparatus of the present embodiment is formed in such a way that the paper slide holder-holding part 11b includes: a paper slide holder-holding mechanism 11b1 capable of pinching a paper slide holder 1 through the both lateral sides of the paper slide holder 1 and capable of releasing a paper slide holder 1 from pinching the paper slide holder 1; and a contact part 11b2 coming into contact with a slide glass sample 2-free area in the middle of the upper face of a paper slide holder 1 pinched by the slide holder-holding mechanism 11b1, slide glass samples 2 being not arrayed on the slide glass sample 2-free area in the middle of the upper face of the paper slide holder 1. As a result, the present embodiment makes it possible to stably hold a paper slide holder 1.

Also, the glass slide transportation apparatus provided for the microscopic image pickup apparatus of the present embodiment is formed in such a way that the wooden slide holder-holding part 11b′ can pinch a cross-shaped lib 1b1′ located in the middle area of the wooden slide holder 1′, from four directions; and the wooden slide holder-holding part 11b′ can release a wooden slide holder 1′ from pinching the wooden slide holder 1′. As a result, the present embodiment makes it possible to stably hold a wooden slide holder 1 and it possible to stably release a wooden slide holder 1′ from pinching the wooden slide holder 1′, without making the structure of the slide holder-holding part large.

Also, the glass slide transportation apparatus provided for the microscopic image pickup apparatus of the present embodiment is formed in such a way that: the slide glass sample-holding part 21a can adhere to a predetermined area of a slide glass samples 2 which is different form a specimen area 2 of the slide glass sample 2; and the slide glass sample-holding part 21a can release adhesion of the slide glass sample-holding part 21a to the predetermined area of a slide glass samples 2 which is different form a specimen area 2 of the slide glass sample 2. As a result, the present embodiment makes it possible to stably hold a slide glass sample 2 and it possible to stably release hold of a slide glass sample 2, with a simple structure.

Also, the glass slide transportation apparatus provided for the microscopic image pickup apparatus of the present embodiment is formed in such a way that: the paper slide holder-holding mechanism 11b1 further includes a paper slide holder adhesion part 11b1₆ capable of adhering to a slide glass sample 2-free area in the middle of the upper face of a paper slide holder 1 and capable of releasing adhesion of the paper slide holder-holding adhesion part 11b1₆ to a slide glass sample 2-free area in the middle of the upper face of a paper slide holder 1a. As a result, the present embodiment makes it possible to float the main body 1a of a paper slide holder 1 in air in holding the paper slide holder 1, so that it becomes easy for a pair of the hook-shaped parts 11b1₂ to pinch a paper slide holder 1 through the both lateral sides of the paper slide holder 1 along the longitudinal direction. In addition, the paper slide holder-holding mechanism 11b1 can hold a paper slide holder 1 yet more stably and can release its hold of a paper slide holder 1 yet more stably.

Also, the glass slide transportation apparatus provided for the microscopic image pickup apparatus of the present embodiment is formed in such a way that: the glass slide transportation apparatus includes a screen (command screen 41e) having a selection area 41e6 through which the type of slide holder (wooden slide holder 1′ or paper slide holder 1) can be selected, and a control unit (first image acquisition mechanism drive-controlling unit 42b, second image acquisition mechanism drive-controlling unit 42c) controlling operation in which the top end of the articulated arm 11a is fitted to or removed from at least different kinds of slide holder-holding parts 11b and 11b′; and the control unit makes the top end of the articulated arm 11a adhere to a slide holder-holding part 11b (or 11b′) corresponding to the type of slide holder which is selected through the screen (command screen 41e) having the selection area 41e6 in driving the slide holder-transporting device 11 (or 11′). As a result, it is possible to automatically fit the articulated arm 11a to the slide holder-holding part 11b (or 11b′) in accordance with different types of slide holders, in the present embodiment.

Also, the glass slide transportation apparatus provided for the microscopic image pickup apparatus of the present embodiment is formed in such a way that the control unit (first image acquisition mechanism drive-controlling unit 42b, second image acquisition mechanism drive-controlling unit 42c) controls: operation of the top end part of the articulated arm 11a adhering to plural kinds of slide holder-holding parts 11b and 11b′ or releasing adhesion of the top end part of the articulated arm 11a to plural kinds of slide holder-holding parts 11b and 11b′; and operation of the top end part of the articulated arm 11a adhering to the slide holder sample-holding parts 21a or releasing adhesion of the top end part of the articulated arm 11a to the slide glass sample-holding parts 21a, in the following manners. That is to say, the control unit (first image acquisition mechanism drive-controlling unit 42b, second image acquisition mechanism drive-controlling unit 42c) triggers the articulated arm 11a so that the top end part of the articulated arm 11a is automatically fitted to a slide holder-holding part 11b (or 11b′) corresponding to the type of slide holder 1 (or 1′) which is selected through the screen (command screen 41e) having the selection area 41e6 when the slide holder-transporting device 11 starts to perform the first transportation operation for the first slide holder 1 (or 1′). And, the control unit triggers the articulated arm 11a so that the top end part of the articulated arm 11a is automatically detached from the slide holder-holding part 11b (or 11b′) and then is automatically fitted to the slide glass sample-holding part 21a when the slide glass sample-transporting device 21 for macro image acquisition starts to perform the second transportation operation for the first slide glass sample 2 arrayed on the slide holder 1 (or 1′). The control unit triggers the articulated arm 11a so that the top end part of the articulated arm 11a is automatically detached from the slide glass sample-holding part 21a and then is automatically fitted to the slide holder-holding part 11b (or 11b′) when the slide holder-transporting device 11 starts to perform the sixth transportation operation for the slide holder 1 (or 1′). And, the control unit makes a control so that the top end part of the articulated arm 11a is automatically detached from the slide holder-holding part 11b (or 11b′) after the slide holder-transporting device 11 finishes performing the sixth transportation operation for the last slide holder 1 (or 1′). As a result, in the present embodiment, it is possible to automatically fit the top end of the articulated arm 11a to a slide holder-holding parts 11b (or 11b′) corresponding to different types of slide holder and the slide glass sample-holding part 21a or to automatically detach the top end of the articulated arm 11a from a slide holder-holding parts 11b (or 11b′) corresponding to different types of slide holder and the slide glass sample-holding part 21a, in all the imaging processes ranging from the imaging process for the whole images of a plurality of slide holders to the imaging process for the micro images of all the slide glass samples 2 arrayed on one slide holder.

Also, the glass slide transportation apparatus provided for the microscopic image pickup apparatus of the example of variations of the present embodiment is formed in such a way that the control unit (first image acquisition mechanism drive-controlling unit 42b, second image acquisition mechanism drive-controlling unit 42c) controls: operation of the top end part of the articulated arm 11a adhering to plural kinds of slide holder-holding parts 11b and 11b′ or releasing adhesion of the top end part of the articulated arm 11a to plural kinds of slide holder-holding parts 11b and 11b′; and operation of the top end part of the articulated arm 11a adhering to the slide holder sample-holding parts 21a or releasing adhesion of the top end part of the articulated arm 11a to the slide glass sample-holding parts 21a, in the following manners. That is to say, the control unit (first image acquisition mechanism drive-controlling unit 42b, second image acquisition mechanism drive-controlling unit 42c) triggers the articulated arm 11a so that the top end part of the articulated arm 11a is automatically fitted to a slide holder-holding part 11b (or 11b′) corresponding to the type of slide holder 1 (or 1′) which is selected through the screen (command screen 41e) having the selection area 41e6 when the slide holder-transporting device 11 starts to perform the first transportation operation for a slide holder 1 (or 1′). And, the control unit triggers the articulated arm 11a so that the top end part of the articulated arm 11a is automatically detached from the slide holder-holding part 11b (or 11b′) and then is automatically fitted to the slide glass sample-holding part 21a when the slide glass sample-transporting device 21 for macro image acquisition starts to perform the second transportation operation for the first slide glass sample 2 arrayed on the slide holder 1. And, the control unit triggers the articulated arm 11a so that the top end part of the articulated arm 11a is automatically detached from the slide glass sample-holding part 21a after the fifth transportation operation for the last slide glass sample 2 is complete. The control unit triggers the articulated arm 11a so that the top end part of the articulated arm 11a is automatically fitted to the slide holder-holding part 11b (or 11b′) when the slide holder-transporting device 11 starts to perform the sixth transportation operation for the first slide holder 1 (or 1′). And, the control unit triggers the articulated arm 11a so that the top end part of the articulated arm 11a is automatically detached from the slide holder-holding part 11b (or 11b′) after the slide holder-transporting device 11 finishes performing the sixth transportation operation for the last slide holder 1 (or 1′). As a result, in this example of variations of the present embodiment, it is possible to automatically fit the articulated arm 11a to a slide holder-holding parts 11b (or 11b′) corresponding to different types of slide holder and the slide glass sample-holding part 21a or to automatically detach the articulated arm 11a from a slide holder-holding parts 11b (or 11b′) corresponding to different types of slide holder and the slide glass sample-holding part 21a, in all the imaging processes ranging from the imaging process for the whole image of each of slide holders to the imaging process for the micro images of all the slide glass samples arrayed on one slide holder and in the process of returning a plurality of slide holders to the predetermined standby position.

Also, the glass slide transportation apparatus provided for the microscopic image pickup apparatus of the present embodiment is formed in such a way that: the glass slide transportation apparatus includes a slide holder-transporting device 11, a slide glass sample-transporting device 21 for macro image acquisition, and a slide glass sample-transporting device 31 for micro image acquisition; the slide holder-transporting device 11 runs downward from the upper part of the glass slide transportation apparatus; and the slide holder-transporting device 11 includes the articulated arm 11a capable of moving in three dimensional directions and the slide holder-holding part 11b provided on the top end part of the articulated arm 11a and holding a slide holder 1 from above or releasing its hold of a slide holder 1. As a result, in the present embodiment, it is possible to acquire the whole images and micro images of all the slide glass samples 2 arrayed on each of all the slide holders 1 in turn while a plurality of slide holders are being stacked in the position P2 in which the images of slide holders are acquired by the slide holder-acquiring device 12. Accordingly, the microscopic image pickup apparatus of the present embodiment does not require another space for stocking slide holders temporarily, so that it is possible to reduce a space for placing apparatus. Because there is no necessity to transport slide holders 1 to another space in order to remove slide holders 1 from the position P2, the efficiency in the whole processes is improved.

Also, the glass slide transportation apparatus provided for the microscopic image pickup apparatus of the present embodiment is formed in such a way that: the slide glass sample-transporting device 21 for macro image acquisition at least includes the articulated arm 11a and a slide glass sample-holding part 21a capable of holding a slide glass sample 2 and capable of releasing its hold of the slide glass sample 2; and the top end part of the articulated arm 11a can automatically adhere to the slide holder-holding parts 11b or to the slide glass sample-holding part 21a from the upper side and can automatically release adhesion of the top end part of articulated arm 11a to the slide holder-holding part 11b or the slide glass sample-holding part 21a. As a result, the present embodiment makes it possible to provide the slide holder-transporting device 11 (or 11′) and the slide glass sample-transporting device 21 with a common component (the articulated arm 11a), so that it is possible to reduce a spaces for placing the transportation devises for transporting slide holders 1 and for taking a slide glass sample 2 from a slide holder 1, to the utmost. In addition, the slide holder-holding part 11b and the slide glass sample-holding part 21a can be quickly exchanged with each other, so that the whole processes become efficient the more.

Also, the glass slide transportation apparatus provided for the microscopic image pickup apparatus of the present embodiment is formed in such a way that: the glass slide transportation apparatus includes an imaging process control section (imaging process control section 42) which controls imaging processes for slide holders 1 and slide glass samples 2; the imaging process control section 42 includes a first image acquisition mechanism drive-controlling unit 42b and a second image acquisition mechanism drive-controlling unit 42c; the first image acquisition mechanism drive-controlling unit 42b performs control on driving of the mechanism for acquiring the images of slide holders for all the slide holders 1 in turn, in such a way that the first image acquisition mechanism drive-controlling unit 42b triggers the slide holder-transporting device 11 to make the slide holder-transporting device 11 perform the first transportation operation and the first image acquisition mechanism drive-controlling unit 42b next triggers the slide holder pickup device 12 to so that the whole image of a slide holder 1 is acquired; the second image acquisition mechanism drive-controlling unit 42c performs control on driving of the mechanism for acquiring the images of slide glass samples for all the slide glass samples 2 arrayed on one slide holder 1 in turn, in such a way that the second image acquisition mechanism drive-controlling unit 42c triggers the slide glass sample-transporting device 21 for macro image acquisition to make the slide glass sample-transporting device 21 perform the second transportation operation, the second image acquisition mechanism drive-controlling unit 42c next triggers the slide glass sample macro-pickup device 22 so that the whole image of a slide glass sample 2 is acquired, the second image acquisition mechanism drive-controlling unit 42c next triggers the slide glass sample-transporting device 31 for micro image acquisition to make the slide glass sample-transporting device 31 perform the third transportation operation, the second image acquisition mechanism drive-controlling unit 42c next triggers the slide glass sample micro-pickup device 32 so that a micro image of a specimen area 2a of the slide glass sample 2 is acquired, the second image acquisition mechanism drive-controlling unit 42c next triggers the slide glass sample-transporting device 31 for micro image acquisition to make the slide glass sample-transporting device 31 perform the fourth transportation operation, and then the second image acquisition mechanism drive-controlling unit 42c next triggers the slide glass sample-transporting device 21 for macro image acquisition to make the slide glass sample-transporting device 21 perform the fifth transportation operation; and then the second image acquisition mechanism drive-controlling unit 42c performs control on driving of the mechanism for exchanging one slide holder 1 with another one for one slide holder, in such a way that the second image acquisition mechanism drive-controlling unit 42c triggers the slide holder-transporting device 11 to make the slide holder-transporting device 11 perform the sixth transportation operation after the completion of control on driving of the mechanism for acquiring the images of slide glass samples with respect to all the slide glass samples 2 arrayed on one slide holder. As a result, while a space for placing the whole of the apparatus is being reduced without providing the apparatus with a space for stocking slide holders 1 temporarily, the present embodiment makes it possible to achieve a microscopic image pickup apparatus in which the whole images and micro images of slide glass samples 2 arrayed on one slide holder are acquired in turn for respective slide holders 1 while a plurality of slide holders 1 are being stacked in the position P2 which the images of slide holders are acquired by the slide holder pickup device 12.

Also, the glass slide transportation apparatus provided for the microscopic image pickup apparatus of the example of variations of the present embodiment is formed in such a way that: the glass slide transportation apparatus includes an imaging process control section (imaging process control section 42) which controls imaging processes for slide holders 1 and slide glass samples 2; the imaging process control section 42 includes a first image acquisition mechanism drive-controlling unit 42b and a second image acquisition mechanism drive-controlling unit 42c; the first image acquisition mechanism drive-controlling unit 42b performs control on driving of the mechanism for acquiring the images of slide holders for one slide holder 1, in such a way that the first image acquisition mechanism drive-controlling unit 42b triggers the slide holder-transporting device 11 to make the slide holder-transporting device 11 perform the first transportation operation and the first image acquisition mechanism drive-controlling unit 42b next triggers the slide holder pickup device 12 to so that the whole image of a slide holder 1 is acquired; the second image acquisition mechanism drive-controlling unit 42c performs control on driving of the mechanism for acquiring the images of slide glass samples for all the slide glass samples 2 arrayed on one slide holder 1 in turn, in such a way that the second image acquisition mechanism drive-controlling unit 42c triggers the slide glass sample-transporting device 21 for macro image acquisition to make the slide glass sample-transporting device 21 perform the second transportation operation, the second image acquisition mechanism drive-controlling unit 42c next triggers the slide glass sample macro-pickup device 22 so that the whole image of a slide glass sample 2 is acquired, the second image acquisition mechanism drive-controlling unit 42c next triggers the slide glass sample-transporting device 31 for micro image acquisition to make the slide glass sample-transporting device 31 perform the third transportation operation, the second image acquisition mechanism drive-controlling unit 42c next triggers the slide glass sample micro-pickup device 32 so that a micro image of a specimen area 2a of the slide glass sample 2 is acquired, the second image acquisition mechanism drive-controlling unit 42c next triggers the slide glass sample-transporting device 31 for micro image acquisition to make the slide glass sample-transporting device 31 perform the fourth transportation operation, and then the second image acquisition mechanism drive-controlling unit 42c next triggers the slide glass sample-transporting device 21 for macro image acquisition to make the slide glass sample-transporting device 21 perform the fifth transportation operation; and then the second image acquisition mechanism drive-controlling unit 42c performs control on driving of the mechanism for returning slide holders for all the single slide holders 1 in turn, in such a way that the second image acquisition mechanism drive-controlling unit 42c triggers the slide holder-transporting device 11 to make the slide holder-transporting device 11 perform the sixth transportation operation after the completion of the control of driving the mechanism for acquiring the images of slide glass samples with respect to all the slide glass samples 2 arrayed on one slide holder 1. As a result, while a space for placing the whole of the apparatus is being reduced without providing the apparatus with a space for stocking slide holders 1 temporarily, the present embodiment makes it possible to achieve a microscopic image pickup apparatus in which the whole images of slide holders and the whole images and micro images of slide glass samples 2 arrayed on one slide holder are acquired in turn for respective slide holders 1 while a plurality of slide holders are being stacked in the position P2 which the images of slide holders are acquired by the slide holder pickup device 12.

Also, when the glass slide transportation apparatus provided for the microscopic image pickup apparatus of the present embodiment includes a correction means automatically correcting variations in imaging acquisition area and magnification in the slide holder pickup device 12 which occurs in accordance with the number of slide holders 1 stacked in the slide-holder-pickup-device-12-imaging position P2 (where the correction means is omitted in the drawings), the glass slide transportation apparatus does not require the regulation for acquiring the whole images of slide holders 1 with the whole images having the same size, in the case where a plurality of slide holders 1 are stacked in the slide-holder-acquiring-device-12-imaging position P2. Accordingly, the efficiency in the whole processes is improved yet more.

Besides, the microscopic image pickup apparatus of the present embodiment is formed in such a way that: the slide glass sample information management screens 41a (m) are displayed together with the command screen 41e; imaging conditions for micro images of specimen areas can be set on the imaging condition-setting screen 41c, through the imaging condition setting screen-displaying tabs 41a1c-n; the slide holder pickup section 10, the slide glass sample macro-pickup section 20, and the slide glass sample micro-pickup section 30 are made to perform their predetermined imaging processes through the imaging process command buttons 41e1 and 41e2, respectively; and the whole images of slide holders are displayed on the slide holder whole image-displaying screen 41b through the slide holder whole image display-switching tab 41e2, the whole images of slide glass samples are displayed on the slide glass sample whole image-displaying areas 41a1b-n (m), and micro images of specimen areas are displayed on the micro image-displaying screen 41d through the micro image display screen-switching tabs 41a1d-n (m), by using respective acquired images. That is to say, in the microscopic image pickup apparatus of the present embodiment, it is presupposed that the whole images of slide glass samples, the whole images of slide holders, and micro images of specimen areas are switched to one another to be displayed while imaging processes are being performed by the pickup sections through predetermined imaging commands with the slide glass sample information management screen 40a (m) displayed. However, microscopic image pickup apparatuses according to the present invention may be formed in such a way that display of the whole images of slide glass samples, the whole images of slide holders, and micro images of specimen areas which are switched to one another with the slide glass sample information management screens 40a (m) displayed is independent of the imaging processes made by these pickup sections.

For example, microscopic image pickup apparatuses according to the present invention may be formed in such a way that: the whole images of slide holders, the whole images of slide glass samples, and micro images of specimen areas are previously acquired and stored in a predetermined storage unit; the previously-acquired whole images of slide glass samples are displayed on the slide glass sample whole image-displaying areas 41a1b-n (m) of the slide glass sample information management screens 40a (m); the previously-acquired whole images of slide holders are displayed on the slide holder whole image-displaying screens 41b through the slide holder whole image display-switching tab 41e2; and the previously-acquired micro images of specimen areas are displayed on the micro image-displaying screen 41d through the micro image display-switching tabs 41a1d-n (m).

Also in microscopic image pickup apparatuses having such a constitution, it is possible to verify the information of acquired images of each of slide glass samples or the like while a state of the slide glass samples arrayed on a slide holder is being checked on screen, by the slide holder which is managed in a hospital. In addition, it is possible to prevent a wrong image acquisition due to confusions between one slide glass sample and another one, and it is possible to efficiently manage the information of slide glass samples.

Microscopic image pickup apparatuses according to the present invention are not limited to the use for pathological diagnoses in hospitals or laboratories and are useful for every field which requires image acquisition for slide glass samples held by slide holders.

What is claimed is:

1. A microscopic image pickup apparatus for picking up slide glass samples, comprising
a slide holder pickup section for picking up the whole image of a slide holder in which a plurality of slide glass samples are arrayed,
a slide glass sample macro-pickup section by which the whole images of the slide glass samples are acquired,
a slide glass sample micro-pickup section by which micro images of specimen areas of the slide glass samples are acquired under predetermined imaging conditions, and
an imaging process control section generating a slide glass sample information management screen for managing slide glass sample information, the slide glass sample information management screen being displayed in such a way that the array of display areas for displaying imaging conditions-setting means for setting the imaging conditions and for displaying the whole images of slide glass samples is paralleled with the array of slide glass samples on the slide holder.

2. A microscopic image pickup apparatus according to claim 1, wherein the imaging process control section generates a slide glass sample information management screen which is displayed in such a way that micro images of specimen areas of the slide glass samples acquired by the slide glass sample micro-pickup section are made to correspond to the whole images of the slide glass samples acquired by the slide glass sample macro-pickup section respectively.

3. A microscopic image pickup apparatus for picking up slide glass samples, comprising
a slide holder pickup section for picking up the whole image of a slide holder in which a slide glass sample is arrayed,
a slide glass sample macro-pickup section for picking up the whole image of the slide glass sample,
a slide glass sample micro-pickup section for picking up a micro image of a specimen area of the slide glass sample under a predetermined imaging condition, and
an imaging process control section which controls imaging processes for the images of the slide holder and the slide glass sample,
wherein
the imaging process control section is provided with a screen display control section and an pickup control section,
the screen display control section generates
a slide glass sample information management screen including display areas each of which displays the information of the slide glass sample and the array of which is paralleled with the array of the slide glass sample on the slide holder,
a slide holder whole image-displaying screen displaying the whole image of the slide holder,
a micro image-displaying screen including a setting area for setting a desired part of a specimen area of the slide glass sample the micro image of which should be displayed and a display area for enlarging and displaying the micro image of the part of the specimen area set through the setting area, and
a command screen for commanding the microscopic image pickup apparatus to perform a predetermined imaging process and to display a predetermined screen, and
the pickup control section drives
the slide holder pickup section so that the whole image of a slide holder is acquired when the microscopic image pickup apparatus is commanded to perform an imaging process on the command screen, and drives the slide glass sample macro-pickup section so that the whole image of the slide glass sample is acquired, and then drives the slide glass sample micro-pickup section so that a micro image of a specimen area of the slide glass sample are acquired.
